(19) United States
(12) Patent Application Publication
(10) Pub. No.: US 2008/0037461 A1
(43) Pub. Date: Feb. 14, 2008

(54) System and Method for Managing Communication Interoperability Switches

(76) Inventors: Gregory F. Biltz, Scottsdale, AZ (US); Gary A. Ruegg, Chandler, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 11/578,309

(22) PCT Filed: Apr. 14, 2005
(86) PCT No.: PCT/US05/12723

§ 371 Date: Oct. 8, 2007

Related U.S. Application Data
(60) Provisional application No. 60/562,633, filed on Apr. 14, 2004.

(51) Int. Cl. H04Q 7/00

(52) U.S. Cl. 370/328

(57) ABSTRACT

A method and system (100) can automatically configure a communication interoperability switch (10) and communication devices associated with the switch (10) to support first responder agency communications based on the type of event for which response is required and the jurisdictions in which the event occurs. The method and system (100) use jurisdiction data, agency data and rules. The jurisdiction data includes data representing one or more jurisdictions, wherein each jurisdiction defines operational boundaries of one or more agencies. The agency data includes one or more communication device frequencies associated with the one or more agencies. The rules include rules for selecting one or more communication device frequencies and one or more networks of the selected communication device frequencies. The rules are used to automatically determine configuration information for configuring the switch (10) to interconnect a communication device to be operated by an agency selected from the one or more agencies. The switch (10) can thereby be configured to interconnect the communication devices operated by a plurality of selected agencies.

### RELATED APPLICATION DATA

This application is based on and claims the benefit of U.S. Provisional Patent Application No. 60/562,633 filed on Apr. 14, 2004, the disclosure of which is incorporated herein by this reference.

### COPYRIGHT NOTIFICATION

Portions of this patent application include materials that are subject to copyright protection by Interop-Solutions, LLC. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates to radio communications. Specifically, it relates to a method and system for automatic and ad-hoc management of communication interoperability switches to support communications among agencies responding to emergency events.

The fundamental interoperability challenge for public safety agencies is over-the-air voice communications among agencies that have different radio systems operating in different radio frequency bands. Technologies exist for interconnecting non-interoperable radio systems so that these various agencies can communicate while responding to an event involving a fire, hazardous material spill or other public safety hazard. For example, the ACU-1000 Modular Interconnect System, manufactured by JPS Communications of Raleigh, N.C., is an implementation of technology that interconnects non-interoperable radio systems. The ACU-1000 is a communications switch that allows wireless communication systems to be combined at the audio baseband by using the received audio from one radio system as the source audio for one or more transmitters of differing technologies. The ACU-1000 is designed to interconnect dissimilar radio systems by distributing the audio or voice-band signals from selected radios (or telephone connections) to other specified radios (or telephone connections) connected to the switch. By connecting directly to each radio's control circuitry, the ACU-1000 switch can detect when a radio on the switch is receiving audio to be distributed to other radios and assert “push-to-talk” on those radios to which the audio is to be transmitted.

The ACU-1000 switch includes interface modules, each designed to connect communication devices such as radios or telephones, a control module and a local operator interface module. The interface modules connect radios, voice-over-IP (VOIP) and/or telephone circuits to the ACU-1000. For each radio system to be connected through the ACU-1000, a portable or mobile radio from the radio system is integrated into the unit through an interface module. Radios can be mounted in a rack with the ACU-1000 or connected remotely through interface cables. The interface modules convert communications traffic into its essential elements: receive and transmit audio, and non-proprietary and/or industry-standard accessory port control signals (required to control the device to which the module is interfacing). Software to control the unit includes a graphical user interface used to connect and disconnect the radios integrated into the unit. Voice prompts give users audible instructions for establishing connections. Setting up connections can be done remotely using standard DTMF tones such as from a telephone keypad. Local control can be provided using a local operator interface module, or using the software interface program running on a PC or laptop

Other examples of technology for interconnecting non-interoperable radio systems include the DS-1600 Intelligent Digital Switch marketed by VDV Media Corporation of Dallas, Tex. and the InfiniMUX G4 digital audio switch marketed by Infinimode Systems, Inc. of Delta, British Columbia, Canada (Vancouver). FIG. 1 shows a typical network utilizing VDV Media Corporation's interoperability switches to interconnect various wireless communication systems.

Although the existing technology allows one to use predefined settings for the switches, there is no easy way to categorize or view the settings by event type or jurisdiction. Configuration of the switches is so time consuming that the event may be over before the switch can be set up. Currently, such switches are used only in emergencies. Yet, they are so technical in nature that a dispatcher cannot remember how to use the switch when an emergency occurs.

There is a need, therefore, for a system and method that can automatically manage voice communication interoperability switches easily and quickly. It is an object and feature of the present invention to provide such a system and method.

It is still a further object and feature of the present invention to provide such a system and method that can be used to enable planning personnel for given jurisdictions to simulate scenarios that would require interoperability switches, thereby allowing such personnel to plan the utilization and configuration of switches for such scenarios.

Additional objects and advantages of the invention will be set forth in the description that follows, and in part will be apparent from the description, or may be learned by practice of the invention. The objects and advantages of the invention may be realized and obtained by means of the apparatus and methods pointed out in the appended claims.

### SUMMARY

To achieve the foregoing objects, and in accordance with the purposes of the invention as embodied and broadly described in this document, there is provided a method and system that can automatically configure a communication interoperability switch and communication devices associated with the switch to support first responder communication based on the type of event and the jurisdictions in which the event occurs. According to the method, the following data is stored in a computer database: jurisdiction data representing one or more jurisdictions, wherein each jurisdiction defines operational boundaries of one or more agencies; agency data including one or more communication device frequencies associated with the one or more agencies; and rules for selecting one or more communication device frequencies and one or more networks of the selected communication device frequencies. The stored rules are used to automatically determine configuration information for configuring the switch to interconnect a communication device to be operated by an agency selected from the one or more agencies. The switch can thereby be configured to interconnect the communication devices operated by the selected agencies. The configuration information can include a plurality of communication devices and one or more nets of the selected communication device frequencies. The switch configuration can be transmitted to the communications switch. According to a preferred method, the rules for selecting communication device frequencies and nets can be based on one or more selected event jurisdictions, a selected event type and a selected event nature. The data stored in the computer database can include incident data including one or more event types and one or more event natures, and the rules for selecting communication device frequencies and nets can be based on a selected incident including a selected event type, a selected event nature and one or more selected event jurisdictions.

A system for automatically configuring a communications switch includes a database for storing data including: jurisdiction data representing one or more jurisdictions, wherein each jurisdiction defines operational boundaries of one or more agencies; agency data including one or more communication device frequencies associated with the one or more agencies; and rules for selecting one or more communication device frequencies and one or more networks of the selected communication device frequencies. An application program is operable with the database to use the stored rules to automatically determine configuration information for configuring the switch to interconnect a communication device to be operated by an agency selected from the one or more agencies. Thereby, the switch can be configured to interconnect the communication device operated by the selected agency with other communication devices. The system can include a transmitter operable with the application program to transmit the switch configuration to the communication interoperability switch. In a preferred embodiment, a mapping program is operable with the database to pass the one or more selected event jurisdictions to the application program in response to an input representing an event location. The configuration information can include a plurality of communication devices and one or more networks of the selected communication device frequencies. The rules for selecting communication device frequencies and nets can based on one or more selected event jurisdictions, a selected event type and a selected event nature. The data stored in the computer database can include incident data including one or more event types and one or more event natures, and the rules for selecting communication device frequencies and nets can be based on a selected incident including a selected event type, a selected event nature and one or more selected event jurisdictions.

When the system is connected to a dispatch center and a switch, the system can automatically configure the switch to the event-derived configuration. This capability allows the supported jurisdiction to utilize the switch on a day-to-day basis. In this way, when a disaster occurs, all first responders and emergency support personnel will be familiar and conversant with interoperable communication systems.

In accordance with the method and system, a state's emergency management personnel can establish the event rules for each jurisdiction. The system can then be used to demonstrate the communications plan for “domestic incidents regardless of cause, size, or complexity, including acts of catastrophic terrorism,” as referenced in the National Incident Management System Draft V8.6, dated Feb. 10, 2004, at any jurisdiction within the borders of the state.

In addition, the system is able to simulate simultaneous events at a jurisdiction. This enables planning personnel to determine the utilization and configuration of hypothetical switches available to a jurisdiction. System planners can then determine actual requirements for the optimal placement and configuration of switches. When the requirements for switches are complete actual switch acquisition and installation can begin.

Utilization of these simulation capabilities enables an Emergency Management organization to demonstrate a complete emergency communications plan for the wide variety of incident activities across agencies and jurisdictions as required by the National Incident Management System (NIMS).

### BRIEF DESCRIPTION OF THE DRAWINGS

The accompanying drawings, which are incorporated in and constitute a part of the specification, illustrate the presently preferred methods and embodiments of the invention and, together with the general description given above and the detailed description of the preferred methods and embodiments given below, serve to explain the principles of the invention.

FIG. 1 is a simplified block diagram of a typical network utilizing interoperability switches to interconnect various wireless communication systems.

FIG. 2 is a simplified functional block diagram of an interoperability configuration system according to a preferred embodiment of the present invention.

FIG. 3 shows an exemplary map display presented by a mapping program, showing the state of Arizona and the surrounding geographic area.

FIG. 4 shows a zoom view of a portion of the map of FIG. 3, which can be displayed by selecting the zooming in or by entering a specific address into the mapping program.

FIG. 5 shows an exemplary display of agencies involved for a selected event type and nature, as specified by the local rules set by the jurisdiction(s) determined from a map.

FIG. 6 shows an exemplary Incident Manager display for viewing all the assets associated with an incident.

FIGS. 7-9 show exemplary Switch Manager screen displays showing all of the assets on the switch and the active incidents on the switch. The Switch Manager interface allows the user to temporarily patch frequencies to additional nets.

FIG. 10 shows an exemplary View Configuration display for viewing a switch configuration based on an event.

FIG. 11 shows an exemplary screen display for establishing a common load for a radio, which load can then be used to set the radio channels for radios.

FIG. 12 shows an exemplary screen display for viewing the definition of a switch and setting or changing the number and type of radios on the switch.

FIG. 13 shows an exemplary screen display for assigning radios to a switch or removing radios from a switch.

FIG. 14 shows an exemplary screen display for establishing initialization rules for a switch.

FIG. 15 shows an exemplary screen display for viewing, modifying, and saving the configuration of a radio device on a switch.

FIG. 16 shows an exemplary screen display for viewing, modifying, and saving the configuration of a dispatch device on a switch.

FIG. 17 shows an exemplary screen display for viewing, modifying, and saving the configuration of a VOIP device on a switch.

FIG. 18 shows an exemplary screen display for viewing, modifying, and saving the configuration of a telephone device on a switch.

FIG. 19 shows an exemplary screen display for viewing or modifying rules for an event.

FIG. 20 shows an exemplary display for viewing information about assets that may be required to respond to an event, such as materials, supplies, vehicles, and the like, and modifying rules for such assets.

FIG. 21 shows an exemplary screen displays for managing the definition of a radio, with which the user can set the range of frequencies and number of channels supported by the radio and the specific frequencies assigned to each available channel.

FIG. 22 shows an exemplary screen displays for showing the current channels available on each radio in the system.

FIG. 23 shows an exemplary screen display for defining jurisdictions and their defaults.

FIG. 24 shows an exemplary screen display for defining high level categories for classifying events.

FIG. 25 shows an exemplary screen display for defining the sub-classifications of an event type by type.

FIG. 26 shows an exemplary screen display for associating an event nature to an event type.

FIG. 27 shows an exemplary screen display for defining the agencies or organizations that become involved in events.

FIG. 28 shows an exemplary screen display for managing the frequencies utilized by agencies as they participate in respective nets.

FIG. 29 shows an exemplary screen display for associating one or more jurisdictions to a census tract.

FIG. 30 shows an exemplary screen display for associating one or more jurisdictions to a zip code.

FIG. 31 shows an exemplary screen display for associating one or more jurisdictions to a territory defined by shape on the map.

FIG. 32 shows an exemplary screen display for maintaining a list of allowable nets to be used in switch configuration and rule specifications.

FIG. 33 shows an exemplary screen displays for maintaining a list of allowable radio bands to be used in radio specifications.

FIG. 34 shows an exemplary screen display for maintaining valid combinations of types and subtypes for resource characterization.

FIG. 35 shows an exemplary screen display for maintaining a list of allowable resource types for resource characterization.

FIG. 36 shows an exemplary a screen display for maintaining a list of allowable subtypes for resource characterization.

FIGS. 37-52 show screen displays illustrating operation of the system for an exemplary simulated scenario involving a federal drug bust with support from local agencies.

FIGS. 53-55 show screen displays illustrating operation of the system for an exemplary simulated scenario involving an explosion at the Tucson International Airport in Tucson, Ariz.

FIGS. 56-59 show screen displays illustrating operation of the system for an exemplary simulated scenario involving a wildfire on Mt. Lemmon near Tucson, Ariz.

FIGS. 60-62 show screen displays illustrating operation of the system for an exemplary simulated scenario involving a traffic accident and tanker spill south of Tucson, Ariz.

FIGS. 63-65 show screen displays illustrating operation of the system for an exemplary simulated scenario involving a passenger train wreck in Tucson, Ariz.

FIGS. 66-69 show screen displays illustrating operation of the system for an exemplary simulated scenario involving a freight train collision with a vehicle near Red Rock, Ariz.

FIGS. 70-72 show screen displays illustrating operation of the system for an exemplary simulated scenario involving an explosion at the border crossing at Lukeville, Ariz.

FIGS. 73-75 show screen displays illustrating operation of the system for an exemplary simulated scenario involving a search and rescue operation in Pima County, Ariz.

### DESCRIPTION

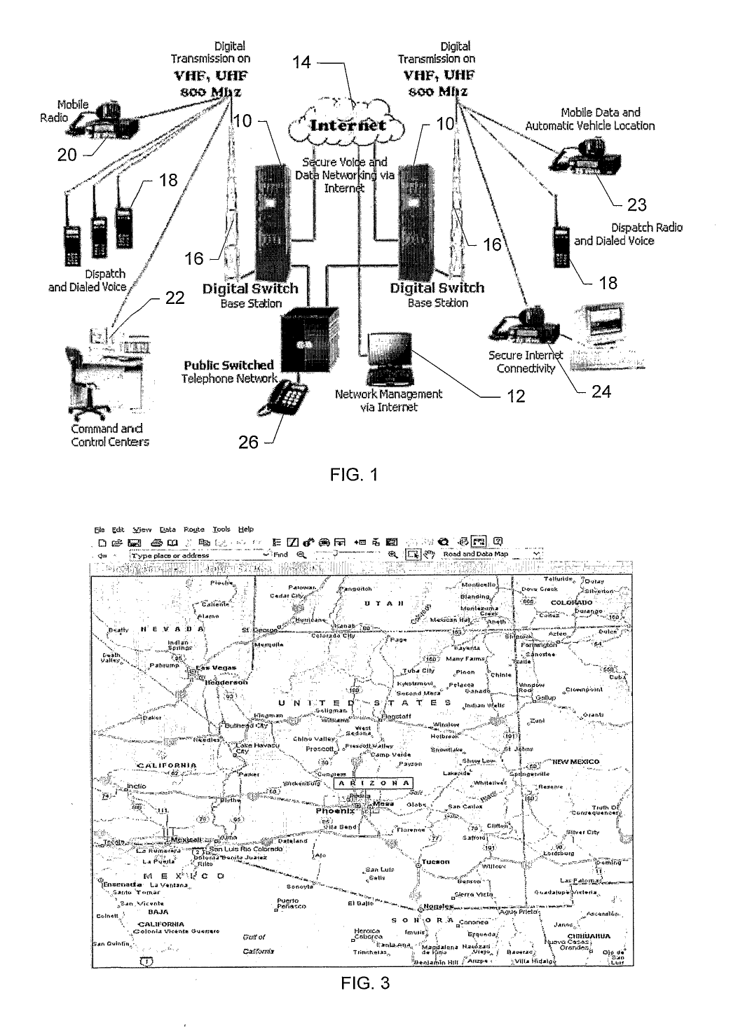

FIG. 1 illustrates a typical communication network utilizing interoperability switches 10 to interconnect various communication devices, such as wireless dispatch and dialed voice communication devices 18, mobile radio 20, a command and control center 22, a tmobile data and vehicle location device 23 and an Internet accessible device 24, as well as a telephone network 26. Each of the switches 10 includes communication devices that can communicate, via a communication tower 16, with the various wireless communication devices. Upon reading this specification, those skilled in the art will understand that wireless communication devices other than those shown also may be included in the communication network. Network management of the switches 10 is performed according to the present invention using a computer system 12, which can communicate to the switches 10 via a communications network medium 14, such as the Internet, which comprises a global network of networks and computers, public and private.

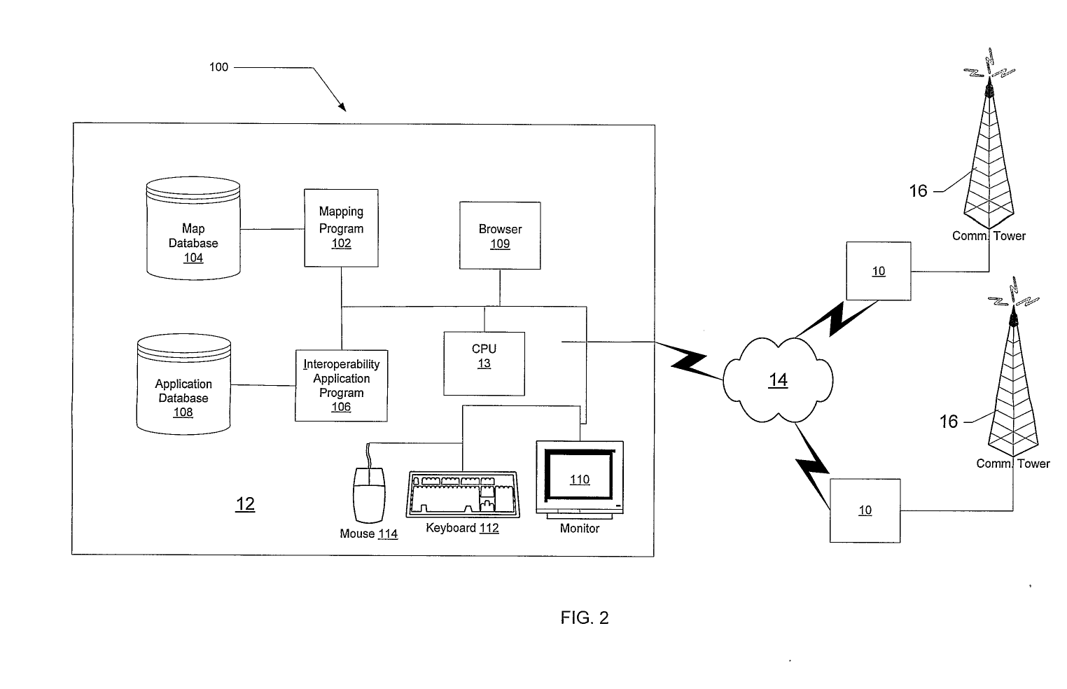

Referring to FIG. 2, a system 100 for automatically configuring the switches 10, according to the present invention, includes a computer system, which may be the computer system 12. The computer system 12 includes a CPU 13 and input and output devices, as is well known in the art. For example, the computer system 12 preferably includes a display screen or monitor 110 for providing graphical output to a user, a keyboard 112 and a mouse 114 for allowing user inputs. The computer system 12 is connected to the network communications medium 14 with the switches 10. In presently preferred embodiments of the invention, the network communications medium 14 comprises the Internet. Upon reading this specification, those skilled in the art will understand that, under appropriate circumstances, considering issues such as developments in computer hardware, software, connectivity and the like, other network configurations and devices also may suffice.

The computer system 12 includes data storage and memory devices, as are known in the art, for storing a mapping program 102, a map database 104, an interoperability application program 106, an application database 108 and a browser 109. The mapping program 102 can communicate with the map database 104, and the interoperability application program 106 can communicate with application database 108. The map database 104 stores territory (i.e., user defined geographical shape), census-tract, and zip code information for all points of a defined geographic map. The mapping program 102 operates with the map database 104 to store and access the territory, census-tract, and zip code information for all points on the map, which the mapping program 102 can display on the monitor 110.

When a user clicks on a point on the displayed map, the mapping program 102 retrieves the nearby territories, census tracts and zip codes, which are then passed to the application program 106. One suitable mapping program is MapPoint Mapping program marketed by Microsoft Corporation of Redmond, Wash. Upon reading this specification, those skilled in the art will understand that other mapping programs may also suffice.

The application program 106 operates with the application database 108 to provide the functionality that will now be described. A preferred object model for the interoperability application program 106 is as follows:

| | |
|---|---|
| 1. | Interoperability application program |

| | |
|---|---|
| a. | Jurisdiction |

| | |
|---|---|
| i. | Census Tract |
| ii. | Zip Code |
| iii. | Territory |

| | |
|---|---|
| b. | Agencies |

| | |
|---|---|
| i. | Map to Jurisdiction |
| ii. | Frequencies |

| | |
|---|---|
| c. | Incident |

| | |
|---|---|
| i. | Incident Details |

| | |
|---|---|
| d. | Switch |

| | |
|---|---|
| i. | Radios |

| | |
|---|---|
| 1. | Frequencies |

| | |
|---|---|
| ii. | Net |

| | |
|---|---|
| 1. | Map to Radios |

| | |
|---|---|
| e. | Local Rules |

| | |
|---|---|
| i. | Event/Nature |
| ii. | Jurisdiction |
| iii. | Agency |
| iv. | Net |
| v. | Frequency |
| vi. | Band |

The following definitions and procedures apply to a preferred object model and application program:

A “jurisdiction” is a geographical area which an agency has authorization to perform services. For example, a jurisdiction can define the operational boundaries for a fire department or a police department. Typically, an emergency event that occurs is handled by the police and fire agencies with jurisdiction at the location of the incident. Multiple jurisdictions can be associated with a given geographic location, such as when a location is within a particular police jurisdiction having given boundaries and a fire jurisdiction that has boundaries that are different than those of the police jurisdiction. In addition, today many jurisdictions have mutual aid agreements (Mutual Aid, Memo of Understanding, MOU) that allow the closest agency to respond regardless of jurisdictional boundaries.

An “agency” is a party that needs to communicate for a given incident. An agency can be a public safety agency or a first responder, such as a police or fire agency. Also, an agency can be a company that provides a product or service that is used by a first responder. According to the present invention, each agency maps to one or more jurisdictions where the agency can operate. Agencies may fall within a jurisdiction but can provide services to multiple jurisdictions.

An “incident” includes an event-type, nature, and jurisdiction(s) sent to a switch (as defined below). In accordance with a preferred system and method of the present invention, all incidents will be logged. The log will show the start date and time of the incident along with the event-type, nature, and jurisdiction(s). The log will also show any changes to the incident over its life and the termination of the incident with the appropriate dates and times. (E.g., changes consist of activities such as adding jurisdictions and agencies, or changing the frequencies used by an agency, or the changing the nature of the event—e.g. when a traffic accident becomes a HAZMAT fire.)

When an incident occurs and is entered into the system by an operator, the system determines the first responders by local rules for the primary jurisdiction(s) (i.e. the jurisdictions geographically containing the incident). When an incident occurs on the border between multiple jurisdictions, all jurisdictions are considered primary. Note also that there are likely to be multiple jurisdictions for a geographical location since fire and law enforcement jurisdictions typically are not coincident.

When a user clicks on a point on a displayed map, such as shown in FIG. 4, the mapping program 102 passes the involved and nearby territories, census tracts and zip codes to the application program 106. The application program 106 will first check to see if a specific territory (i.e. user defined geographical shape) is available. If so it will look up the jurisdictions from the territory table. If no jurisdiction has been determined then it will check the census tract for a jurisdiction, and then the zip code. This provides the user with the ability to simplify the definition of jurisdictions. They need only be defined at as low a level as necessary—i.e., if a jurisdiction is fully defined by zip code(s) or census tract(s), no geographical shape need be created. If there are nearby jurisdictions (i.e., the event is on the border between jurisdictions) each jurisdiction is identified by the same process.

The “local rules” define the nets (defined below) and the agencies that need to communicate for a given type of event, nature of event and jurisdiction. The local rules may also stipulate the frequencies that the agencies will use for communication. As specified by the mutual aid agreement previously discussed. According to a preferred method of the present invention, if the local rules do not stipulate the frequency, then the frequency will be determined from a relevant agency's frequencies as follows:
1. Use mutual aid frequency for the specified net if multiple jurisdictions are involved or if specified by the event/nature combination;
2. Use the agency's tactical ground frequency for the specified net if available; and
3. Use the agency's command frequency for the specified net.
   Note that command nets will always default to the command frequency. When multiple incidents occur within proximity of each other (proximity is determined by the jurisdiction) the system will automatically seek alternate frequencies.

A “switch” is set of communication devices (radio, VOIP, and/or phone) that can be interconnected on a set of nets. Each interoperable device on the switch has a type (dispatch, VOIP, radio, or phone) and each radio has a defined frequency. Each manufacturer's switch has a defined number of possible simultaneous connections. A switch may be assigned separate URL addresses for the switch and device control. When a URL address is present the system will send a message to the URL to physically control the switch and radios respectively. When the URL address indicates switch or radio configuration is required but there is no response from the address the user will be notified and the event will be logged. A switch can be manually determined or automatically selected based on the geographical location of the event. Additional switches may supplement a switch if the switches are within range (capable of radio coverage) of the event. For example, a mobile unit may be moved in to provide additional capability or a county switch may in turn supplement the city switch.

A “network” or “net” is a named set of interoperable frequencies. Nets are usually a functional grouping of radio frequencies. For example, all firefighters are on the same net.

A “radio” is a device that communicates on a specified range of frequencies (band) that may have up to 500 pre-programmed frequencies (all within the specified range) defined by channel group and channel. The radio is defined by a unique identifier. Some bands utilize talk groups. Some radios utilize tone to provide security/privacy.

An “asset” is a physical communication device such as a radio or switch.

A “resource” is anything required by a first or second responder during an incident other than communication assets.

When an incident occurs and is entered into the system, the system creates an incident identifier, the involved agencies are associated with the incident identifier, and when the incident has been confirmed (i.e. when the operator selects the Save Configuration or Configure Switch button) the event and its particulars are sent to a switch 10 to configure it. The incident specifies the number, name, and frequencies of interconnections required. The switch must then:
1. Check for the available radios (i.e. for the band required and that contain the frequency specified);
2. Change the radios to the requested frequency and tone or talk group;
3. Mark the radios as in use and assign the radios to the appropriate nets;
4. Check that there are available nets;
5. Setup the required nets; and
6. Log the start of the event

When an incident is terminated the switch must:
1. Log the termination of the incident;
2. Free the nets (take the selected radios off the nets); and
3. Free the radios

An incident changes in two ways:
1. Life cycle changes—Many incidents change as the incident progresses over time. An example of this is a flood, which begins as an Evacuation, followed by a Search and Rescue Operation, which is then followed by Clean Up. Another example may be a “Bomb Threat” that becomes a Terrorist Explosion.
2. Escalation—When an incident requires assets or resources beyond the capability of the primary jurisdiction(s), then the incident escalates and additional jurisdictions (and/or switches) are brought in.
   In a presently preferred embodiment, the system will not automatically remove assets from an incident. As resources depart, the dispatcher may remove the links and free the assets. The system will, however, automatically make the additions to the incident that are required to support the life cycle or escalation change that is occurring

When there are not enough resources on the switch, the application program will:
1. Notify the operator of the shortage (radios by type or nets);
2. Ask the operator to assign an additional switch;
3. Ask the operator to free resources;
4. Ask the operator to prioritize the interoperable nets/frequencies.

When an incident occurs and is entered into the system, the application program records the location of the incident and the frequencies utilized by the incident. When additional incidents occur before the completion of the first incident, the application looks up the maximum mobile coverage area (maxmobilearea) for the jurisdiction. It uses the largest maximum mobile coverage area when multiple jurisdictions are involved. The system then looks up the active incidents and computes the distance between each active incident and the new incident. If the distance is less than the maximum mobile coverage area then all frequencies in use for that incident are added to an unusable array. When frequencies are being assigned the frequencies are compared to the unusable frequencies. When an unusable frequency is encountered it is discarded and the system attempts to find alternate useable frequencies. If no usable frequencies are found; the system will alert the operator that manual frequency assignment is required

Modes of Operation

Preferably, the system is designed for day-to-day use on the premise that if a tool is not used day-to-day it will not be able to be used when there is an emergency. As a result a preferred system can support several modes of operation as follows:

Red Alert: When an officer goes down he/she is not particular as to whether the help comes from the local police, the county sheriff, or the highway patrol. When the dispatcher clicks on the switch “All Call” button, all radios that are not already assigned to an incident are patched together so that all agencies are simultaneously notified/dispatched. Each incident has an individual “All Call” button. When the dispatcher clicks the incident “All Call” button, all the radios on that incident are automatically linked together.

Day-to-Day: The default configuration of radios on a switch provides for the most common day-to-day interactions. The switch may contain radios on the local police frequency, the county sheriff's frequency, the highway patrol frequency, the local fire department, the local EMS, and a contract towing service. During normal day-to-day operations the dispatcher is in a position to field interoperability requests from any of the agencies to any of the other agencies. For example, during a routine traffic stop the local police officer may see an outstanding county warrant and want to speak to the sheriff's office about it.

Incident: When something happens that requires specific assets, the system may dynamically need to be reconfigured to support the incident. In addition, specific connections (patches) may be pre-established to support a known need for interoperability.

Unified Command: When a large-scale emergency happens, the first responders organize themselves in a unified command structure. An incident commander is identified and assumes command and control for all first responders at the incident site. Area or functional commanders report directly to the incident commander, and all participating first responders report to the area or functional commanders.

System Operations

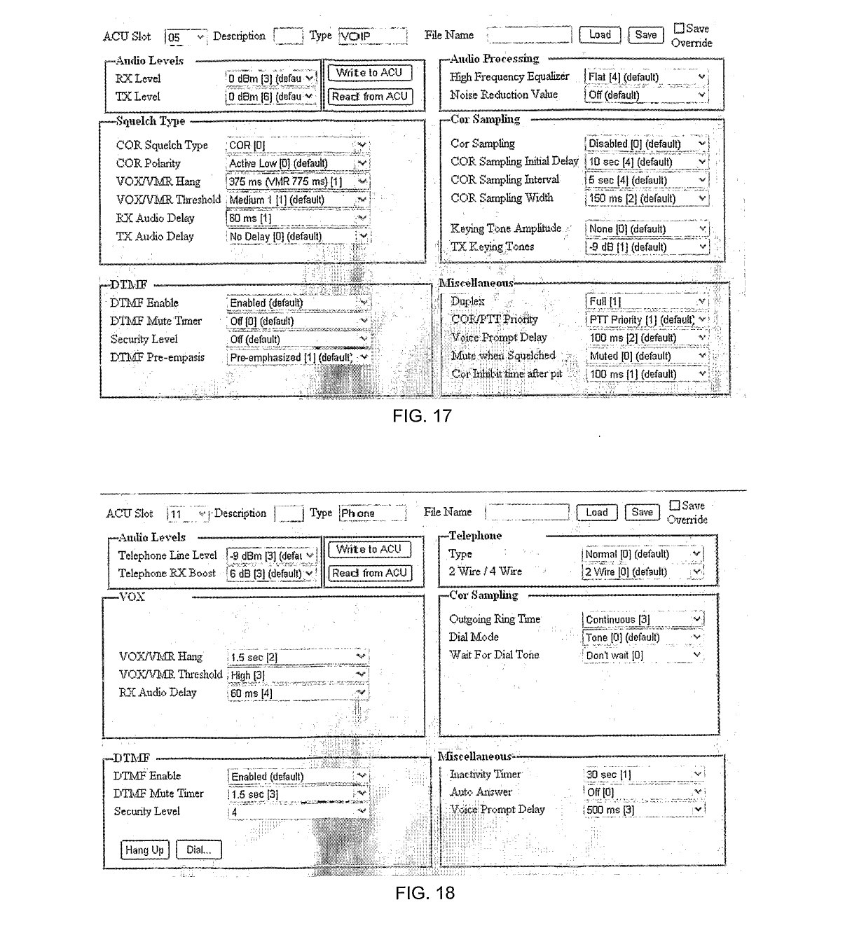

Operation of the system will now be described with reference to the graphical user interface depicted in FIGS. 3-36 and the transactions performed by the interoperability application program 106.

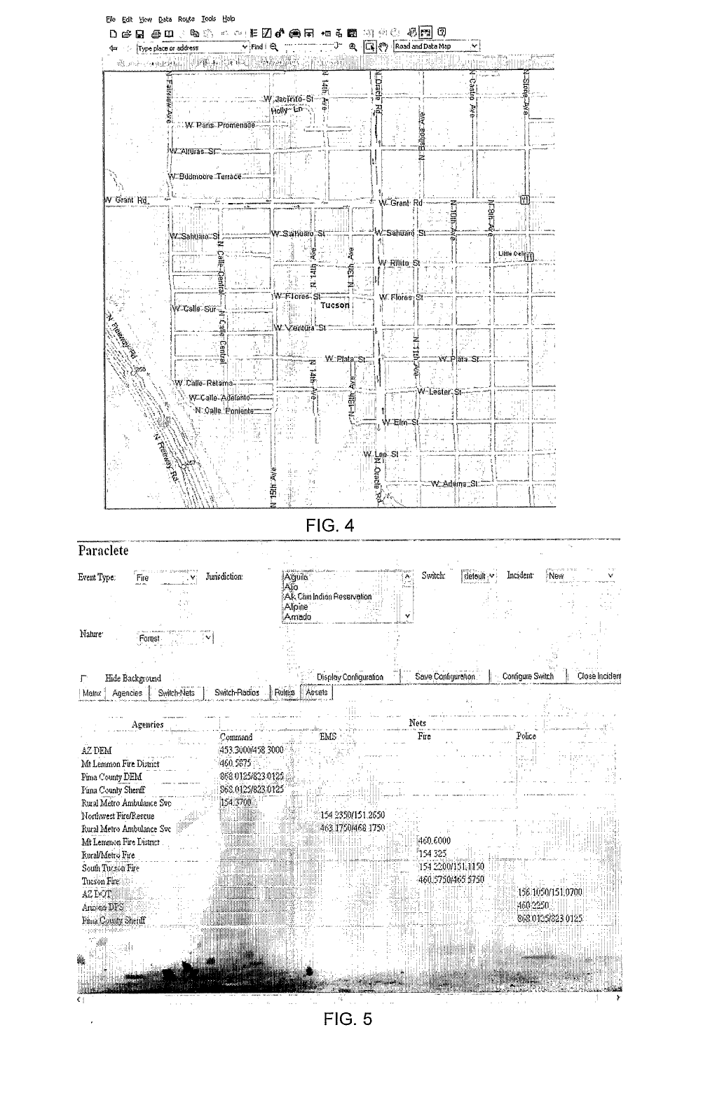

FIG. 3 shows an exemplary map displayed by the mapping program on the monitor 110. FIG. 4 shows a zoom view of a portion of the map of FIG. 3, which can be displayed by selecting the zoom in button or by entering a specific address into the mapping program 102. When the system operator receives a request to enter an event into the system, such as a 911 telephone call, the operator begins by entering the address or location of the incident using the mapping program. After the address or location is entered, the operator launches the interoperability application program by selecting the Tools menu option and then selecting a Link to Interoperability Application option (not shown). The interoperability application will then display a main screen like that shown in the top portion of FIG. 5. Preferably, the map display also remains on the monitor 110. Jurisdiction information and default switch information is passed from the mapping program 102 to the application program 106 and displayed as shown in FIG. 5. The operator can then select the Event Type and the Event Nature from the pull down menus on the main screen. The operator can then select the Display Configuration button, and the system displays the involved Agencies and related information shown in the lower portion of FIG. 5, which is stored in the application database 102. The Agencies are entered into the system using the Maintain Agency transaction discussed below. In the preferred embodiment, the information shown in FIG. 5 cannot be modified until the switch configuration is saved. This allows the system to log all changes to the switch configuration.

### Create Event

The Create Event transaction allows a dispatcher to search for an address, select a location and enter an incident into the system, as described above. The monitor 110 displays a map (see FIGS. 3 and 4) on which pushpins can be displayed based on the Type and Nature of the Incident. For example, if the event is a hazardous material event, only the fire stations with hazardous material capability will be displayed on the map. Where automatic vehicle location (AVL) is operable, the involved Assets will display on the map as they are dispatched.

### View Involved Agencies

The View Involved Agencies transaction takes control from the mapping program 102. The transaction shows the agencies involved for the selected event type and nature as specified by the local rules set by the jurisdiction(s) determined from the map. The application program 106 selects the default switch from the jurisdiction. The transaction allows the user to configure the agencies/frequencies/nets and then save the incident and configure the switch. When control is passed from the map, the incident defaults to “New.” FIG. 5 is an exemplary View Involved Agencies display showing the agencies involved in a particular combination of event type, nature, and jurisdiction. The user can modify the switch, jurisdictions, event type and/or nature before saving the configuration by selecting the Save Configuration button. When the configuration has been saved, an Incident ID is created from the date/time. The user can modify the agencies by adding an agency, changing the frequency that an agency is to use or by changing the net that a frequency is in. A user may want to change the channel assigned by the system for an agency since agencies frequently have many usable frequencies. A user may want to consolidate nets when the number of participants is small or the resources are required to support other incidents. When adding an agency the frequency may be left as “default” and the system will use the net default for that agency. When the user has the Incident configuration complete, it can be saved and sent to the selected switch(s). Should the nature of the event change (for example a traffic accident becomes a hazardous material incident, or an additional jurisdiction becomes involved) the user may modify the parameters for the incident and the resultant configuration will be added to the current configuration (after eliminating duplicates). The user may then modify the agencies, nets, and frequencies as before.

In a normal operating mode the user will simultaneously deal with multiple displays. These can be:
1. The Map display (see FIG. 4), which shows the related assets (fire stations, police stations, hospitals, etc.). The map display may also show the radio coverage areas, the radio towers etc. When automatic vehicle locating (AVL) software is employed the map will display the location of related assets (such as vehicles in route).
2. The Switch Manager display (see FIGS. 7-9), which allows the user to temporarily patch frequencies to additional nets (allow the police officer to talk to the EMS personnel without leaving the police net or vice versa).
3. The View Involved Agencies display (see FIG. 5), which allows the user to easily add to or change the current configuration as the incident evolves and changes over its life cycle.

When the incident has been saved the system allows the dispatcher to modify the defined agencies, nets and frequencies to match them to reality. Not all agencies configured in the rules may be available. In addition, unplanned resources may be available. When the configuration is correct the dispatcher configures the switch and moves to either the incident or switch manager.

According to a preferred embodiment, the database schema for the View Involved Agencies transaction is as follows:

1. Event Header (Keyed by Event_Id)

| Name | Schema | Datatype | Size | Scale | Ref | Nulls? | Default Value |
|---|---|---|---|---|---|---|---|
| EVENT_ID | <None> | VARCHAR2 | 20 | | | | |
| EVENTTYPE | <None> | VARCHAR2 | 32 | | | | |
| NATURE | <None> | VARCHAR2 | 20 | | | | |
| SWITCH_USED | <None> | VARCHAR2 | 20 | | | | |
| DATE_STARTED | <None> | DATE | | | | | |
| DATE_CLOSED | <None> | DATE | | | | ✓ | |
| JURISTICTION_NAMES | <None> | VARCHAR2 | 200 | | | | |
| LONGITUDE | <None> | VARCHAR2 | 12 | | | ✓ | |
| LATITUDE | <None> | VARCHAR2 | 12 | | | ✓ | |

Note:
Longitude/latitude format (ddd.mm.ffff D) where ddd is degrees, mm is minutes and ffff is decimal fractions of a minute and D is (N, S, E, or W)

2. Event (Keyed by Event_Id, Seq)

| Name | Schema | Datatype | Size | Scale | Ref | Nulls? | Default Value |
|---|---|---|---|---|---|---|---|
| EVENT_ID | <None> | VARCHAR2 | 20 | | | | |
| SEQ | <None> | NUMBER | 0 | 0 | | | |
| AGENCY | <None> | VARCHAR2 | 32 | | | ✓ | |
| NET | <None> | VARCHAR2 | 20 | | | ✓ | |
| FREQUENCY | <None> | VARCHAR2 | 20 | | | ✓ | |
| SWITCH_ID | <None> | VARCHAR2 | 20 | | | | |

Referring again to FIG. 5, the system allows the dispatcher to view the rules used to create the configuration via the “Rules” tab on the display. The dispatcher may also view resources by type and subtype that are normally required to support the incident. The resource list provides contact information in source preference sequence. Thus, when an incident commander notifies the dispatcher that a resource is needed the dispatcher can quickly find a source for the resource.

### Incident Manager

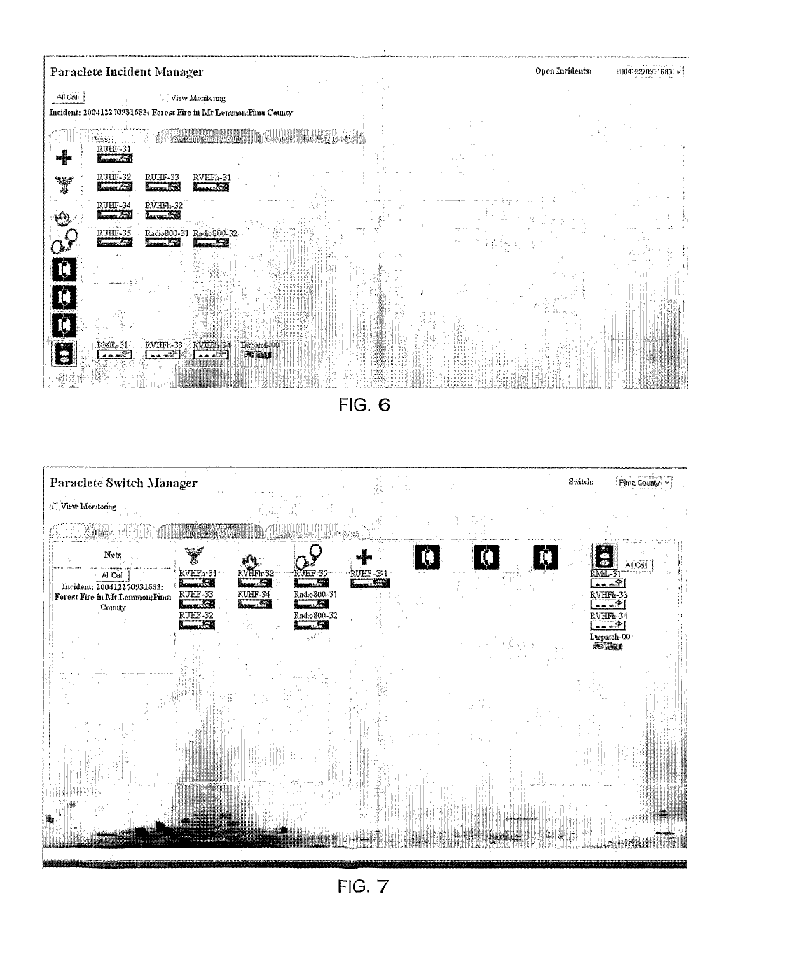

The Incident Manager is a transaction that allows the dispatcher to view all the assets associated with an incident. FIG. 6 shows an exemplary Incident Manager display. A large incident may span multiple switches. Each asset is color coded to the switch. Available (un-assigned) assets are shown in the “Available” Net—the net with a traffic light icon. The dispatcher can mouse-over the assets to see the agencies, frequencies, etc. supported by the asset. On demand the dispatcher can click on radios and “drag” them together to form patches. In the example shown in FIG. 6, there are three active patches (connections): one on the Command Net (the eagle icon) with three radios, one on the Fire Net with two radios, and one on the Police Net with three radios. In the event that an emergency communication is necessary to be made to all parties in the incident, the “All Call” button is depressed by the dispatcher and a temporary connection is made to all radios on the incident. The radios are color coded to match the tab color of the switch they are on. When there is more than one switch supporting an incident there is a tab for each switch. The user can switch to a Switch Manager by simply clicking the tab.

### Switch Manager

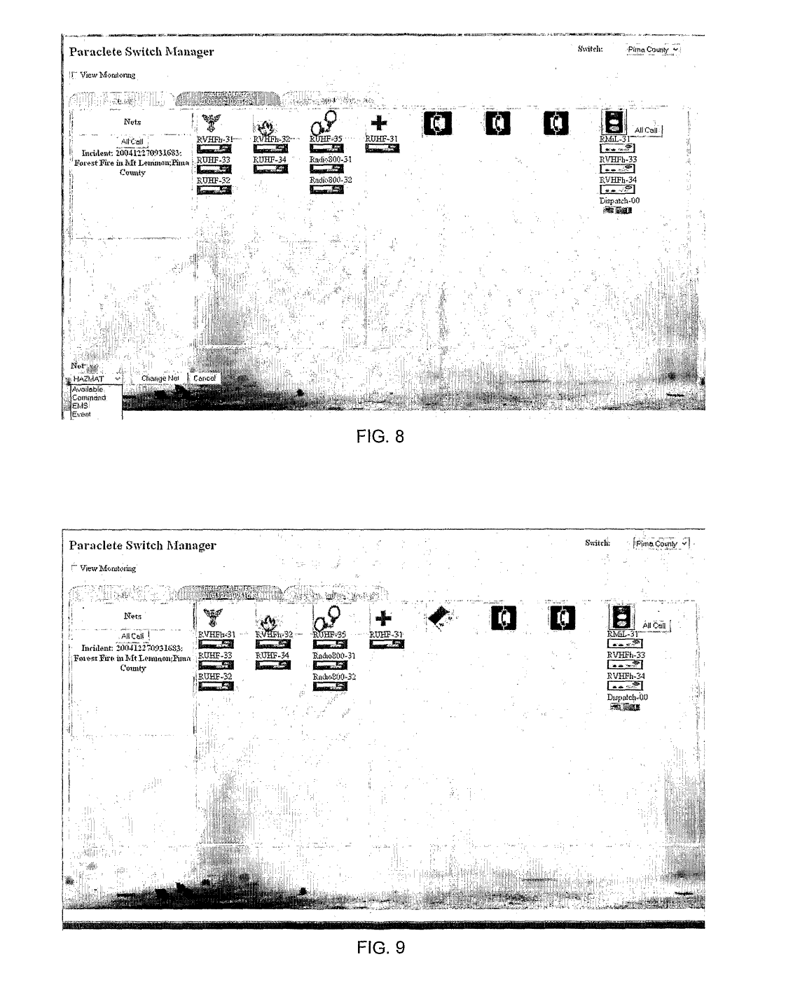

During normal operations the dispatcher will operate from the Switch Manager screen display. FIGS. 7-9 show exemplary Switch Manager screen displays. The Switch Manager shows all the assets on the switch and shows the active incidents on the switch. The assets are color coded to the incident so the dispatch can easily see each incident's assets. Available (un-assigned) assets are shown in the “Available” net—the Net with a traffic light icon. A column with multiple assets reflects active connections (patches). The dispatcher can mouse-over the asset to see the agencies, frequencies, etc. supported by the asset. On demand the dispatcher can drag radios together to form patches. In the example of FIG. 7, there are three active patches (connections): one on the Command Net (the eagle icon) with three radios, one on the Fire Net with two radios, and one on the Police Net with three radios. Each resource has a “Home Net.” Resources within a connection can be returned to their “Home Net” by double clicking on the Net icon. Net icons can be modified as required by clicking on the icon. When a net icon is clicked a drop down list of net names appears at the bottom of the display, as shown in FIG. 8. A net may be selected and “Change Net” depressed. The selected Icon will then appear on the display. For example, as shown in FIG. 9, a HAZMAT not has been added to the display.

### View Configuration

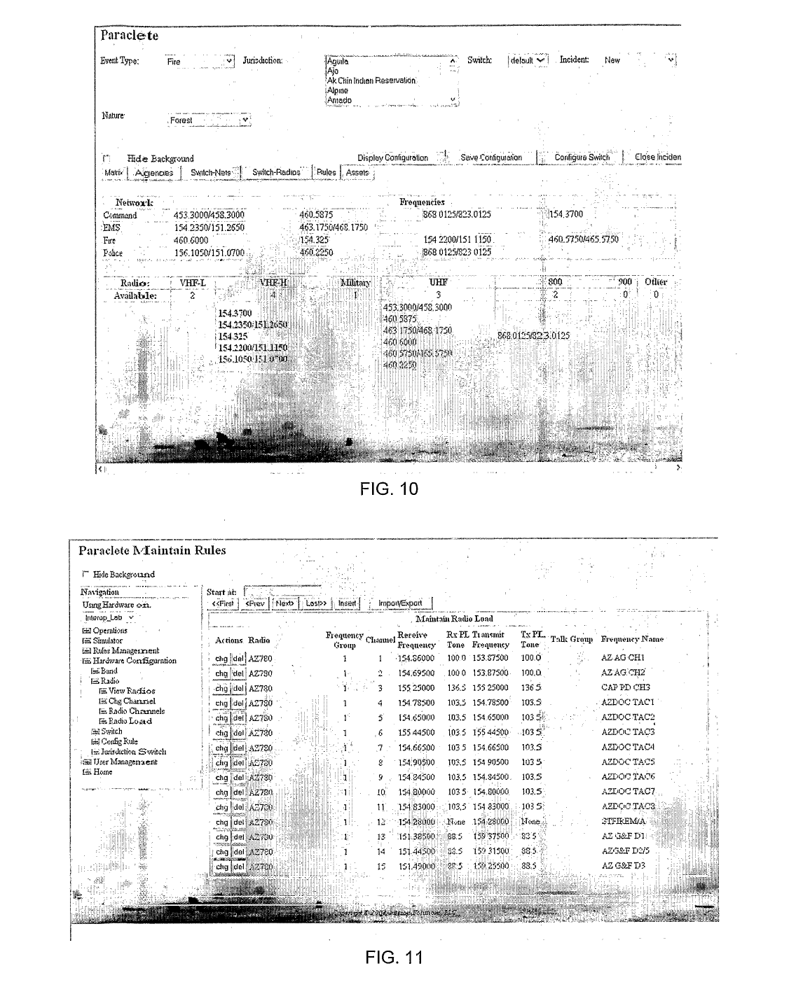

The View Configuration transaction displays the switch configuration based on the event. FIG. 10 shows an exemplary View Configuration display (which is displayed by selecting the Display Configuration button). When a switch has been configured, the display shows the radios on the switch as well as the networks to be configured, with frequencies grouped by network. When the nature of an event at a jurisdiction(s) causes a configuration that cannot be handled by the switch (for example there are more vhf high band frequencies to be handled than there are vhf high band radios on the switch or there is a requirement for a vhf high band frequency that is not on any of the vhf high band radios on the switch); the affected frequencies display in red, as shown in FIG. 10. When the Save Configuration button is selected, the system creates an incident identifier. When the Close Incident button is selected, the system terminates the incident.

### Maintain Radio Load

The Maintain Radio Load transaction allows the user to establish a common load for radio. The load can then be used to set the radio channels for radios. FIG. 11 shows an exemplary Maintain Rules screen display for this purpose.

According to a preferred embodiment, the database schema for this transaction is as follows:

1. Radio Load (Keyed by Radio Load, Frequency Group, Channel)

| Name | Schema | Datatype | Size | Scale | Ref | Nulls? | Default Value |
|---|---|---|---|---|---|---|---|
| RADIOLOAD | <None> | VARCHAR2 | 20 | | | | |
| FREQUENCY_GROUP | <None> | NUMBER | 3 | 0 | | | |
| CHANNEL | <None> | NUMBER | 4 | 0 | | | |
| RECEIVE_FREQUENCY | <None> | VARCHAR2 | 20 | | | | |
| RX_PL | <None> | VARCHAR2 | 10 | | | ✓ | |
| TRANSMIT_FREQUENCY | <None> | VARCHAR2 | 20 | | | ✓ | |
| TX_PL | <None> | VARCHAR2 | 10 | | | ✓ | |
| TALK_GROUP | <None> | VARCHAR2 | 20 | | | ✓ | |
| FREQUENCY_NAME | <None> | VARCHAR2 | 20 | | | ✓ | |

### Maintain Switch

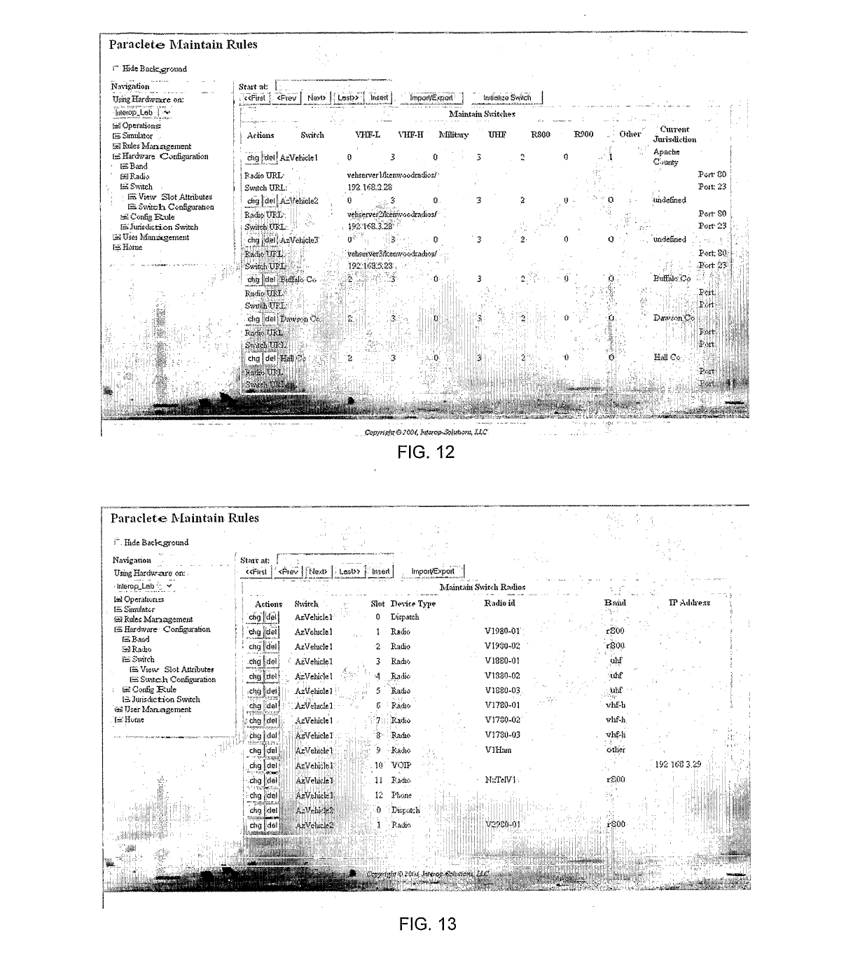

The Manage Switch transaction allows the user to view the definition of a switch. FIG. 12 shows an exemplary Maintain Rules screen display for this purpose. The user can set or change the number and type of radios on the switch. The transaction provides an “Initialize Switch” button, which allows a communications engineer to define (or redefine) all the radio channels for all radios on the switch at once. This is especially useful for mobile switches that will need different loads when the vehicle is moved from one location to another.

According to a preferred embodiment, the database schema for this transaction is as follows:

1. MSwitch (Keyed by Mswitch)

| Name | Schema | Datatype | Size | Scale | Ref | Nulls? | Default Value |
|---|---|---|---|---|---|---|---|
| MSWITCH | <None> | VARCHAR2 | 20 | | | | |
| VHF_L | <None> | NUMBER | 2 | 0 | | ✓ | |
| VHF_H | <None> | NUMBER | 2 | 0 | | ✓ | |
| UHF | <None> | NUMBER | 2 | 0 | | ✓ | |
| R800 | <None> | NUMBER | 2 | 0 | | ✓ | |
| MILITARY | <None> | NUMBER | 2 | 0 | | ✓ | |
| R900 | <None> | NUMBER | 2 | 0 | | ✓ | |
| OTHER | <None> | NUMBER | 2 | 0 | | ✓ | |
| MAX_RADIOS | <None> | NUMBER | 2 | 0 | | ✓ | |
| MAX_NETS | <None> | NUMBER | 2 | 0 | | ✓ | |
| CURRENT_NETS | <None> | NUMBER | 3 | 0 | | ✓ | |

### Maintain Switch Radios

The Manage Switch Radios transaction supports switch definition and allows radios to be assigned or removed from a switch. FIG. 13 shows an exemplary Maintain Rules screen display for this purpose. With the rule maintenance transaction, the user can assign a URL to the switch to allow the switch to control the interoperability device.

1. Switch_Radios (Keyed by Switch_Id, Slot)

| Name | Schema | Datatype | Size | Scale | Ref | Nulls? | Default Value |
|---|---|---|---|---|---|---|---|
| SWITCH_ID | <None> | VARCHAR2 | 20 | | | | |
| SLOT | <None> | NUMBER | 3 | 0 | | | |
| RADIO_ID | <None> | VARCHAR2 | 20 | | | ✓ | |
| BAND | <None> | VARCHAR2 | 10 | | | ✓ | |
| CHANNEL_GROUP | <None> | NUMBER | 3 | 0 | | ✓ | |
| CHANNEL | <None> | NUMBER | 4 | 0 | | ✓ | |
| FREQUENCY | <None> | VARCHAR2 | 20 | | | ✓ | |
| TALK_GROUP | <None> | VARCHAR2 | 20 | | | ✓ | |
| EVENT_ID | <None> | VARCHAR2 | 20 | | | ✓ | |
| TONE_TYPE | <None> | VARCHAR2 | 3 | | | ✓ | |
| TONE | <None> | VARCHAR2 | 10 | | | ✓ | |
| COMM_PORT | <None> | NUMBER | 2 | 0 | | ✓ | |
| FREQUENCY_NAME | <None> | VARCHAR2 | 20 | | | ✓ | |

### Maintain Config Rule

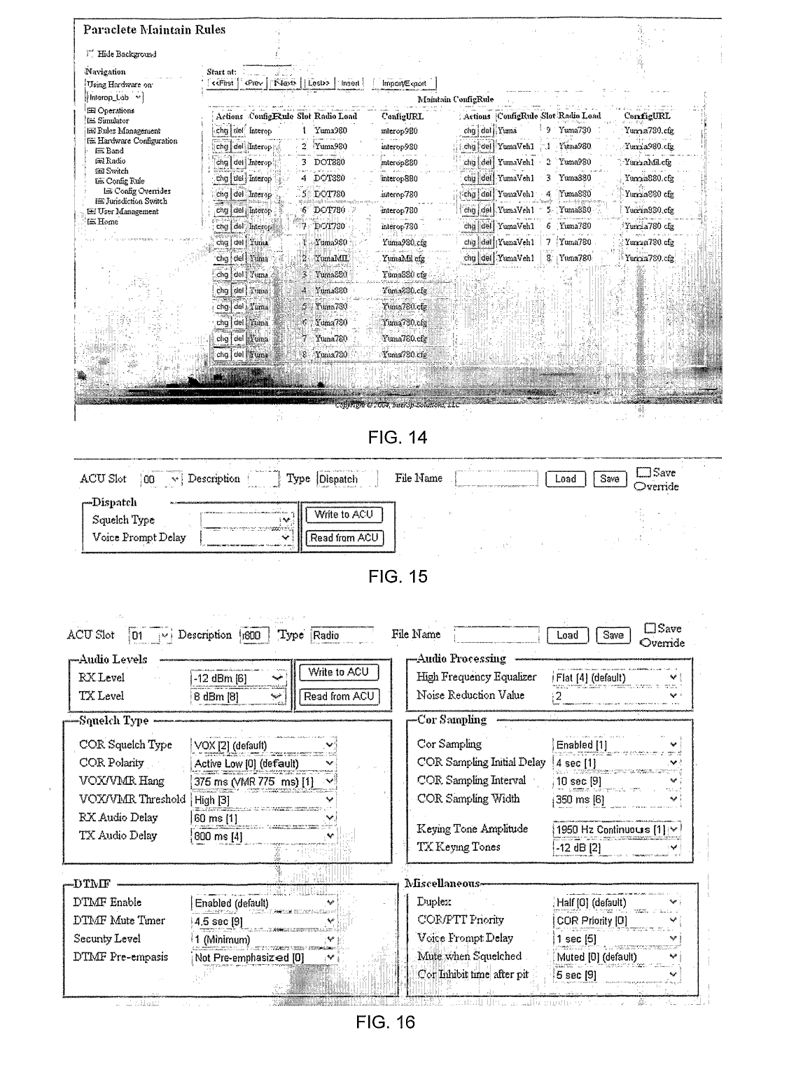

The Maintain Config Rule transaction allows the communications engineer to establish initialization rules for a switch. FIG. 14 shows an exemplary Maintain Rules screen display for this purpose. There is a rule entry for each slot (device) on the switch. Each slot is configured on the switch with the audio characteristics contained in the film specified in configURL. Each radio contains the load (set of channels or talk groups) defined by the radio load specified in Radio Load.

According to a preferred embodiment, the database schema for this transaction is as follows:

1. Config Rule (Keyed by ConfigRule, Slot)

| Name | Schema | Datatype | Size | Scale | Ref | Nulls? | Default Value |
|---|---|---|---|---|---|---|---|
| CONFIGRULE | <None> | VARCHAR2 | 20 | | | | |
| SLOT | <None> | NUMBER | 4 | 0 | | | |
| CONFIGURL | <None> | VARCHAR2 | 128 | | | | |
| RADIO_LOAD | <None> | VARCHAR2 | 20 | | | ✓ | |

### Manage Switch Nets

The system, in the background, manages the state of the switch. According to preferred embodiment, the database schema for switch management is as follows:

1. MSwitch (Keyed by Mswitch)

| Name | Schema | Datatype | Size | Scale | Ref | Nulls? | Default Value |
|---|---|---|---|---|---|---|---|
| MSWITCH | <None> | VARCHAR2 | 20 | | | | |
| VHF_L | <None> | NUMBER | 2 | 0 | | ✓ | |
| VHF_H | <None> | NUMBER | 2 | 0 | | ✓ | |
| UHF | <None> | NUMBER | 2 | 0 | | ✓ | |
| R800 | <None> | NUMBER | 2 | 0 | | ✓ | |
| MILITARY | <None> | NUMBER | 2 | 0 | | ✓ | |
| R900 | <None> | NUMBER | 2 | 0 | | ✓ | |
| OTHER | <None> | NUMBER | 2 | 0 | | ✓ | |
| MAX_RADIOS | <None> | NUMBER | 2 | 0 | | ✓ | |
| MAX_NETS | <None> | NUMBER | 2 | 0 | | ✓ | |
| CURRENT_NETS | <None> | NUMBER | 3 | 0 | | ✓ | |

2. Switch_Nets (Keyed by Switch_Id, Seq)

| | | | | | | | |
|---|---|---|---|---|---|---|---|
| Name | Schema | Datatype | Size | Scale | Ref | Nulls? | Default Value |

| | | | | |
|---|---|---|---|---|
| SWITCH_ID | <None> | VARCHAR2 | 20 | |
| SEQ | <None> | NUMBER | 4 | 0 |
| EVENT_ID | <None> | VARCHAR2 | 20 | |
| NET | <None> | VARCHAR2 | 20 | |
| RADIO_ID | <None> | VARCHAR2 | 20 | |

### View Slot Attributes

The View Slot Attributes transaction allows the user to view, modify, and save the configuration of the assets on the switch. The attributes vary by asset type. FIGS. 15-18 show exemplary screen display for various assets, including dispatch, radio, VOIP and telephone communication devices, respectively.

### Manage Local Rules

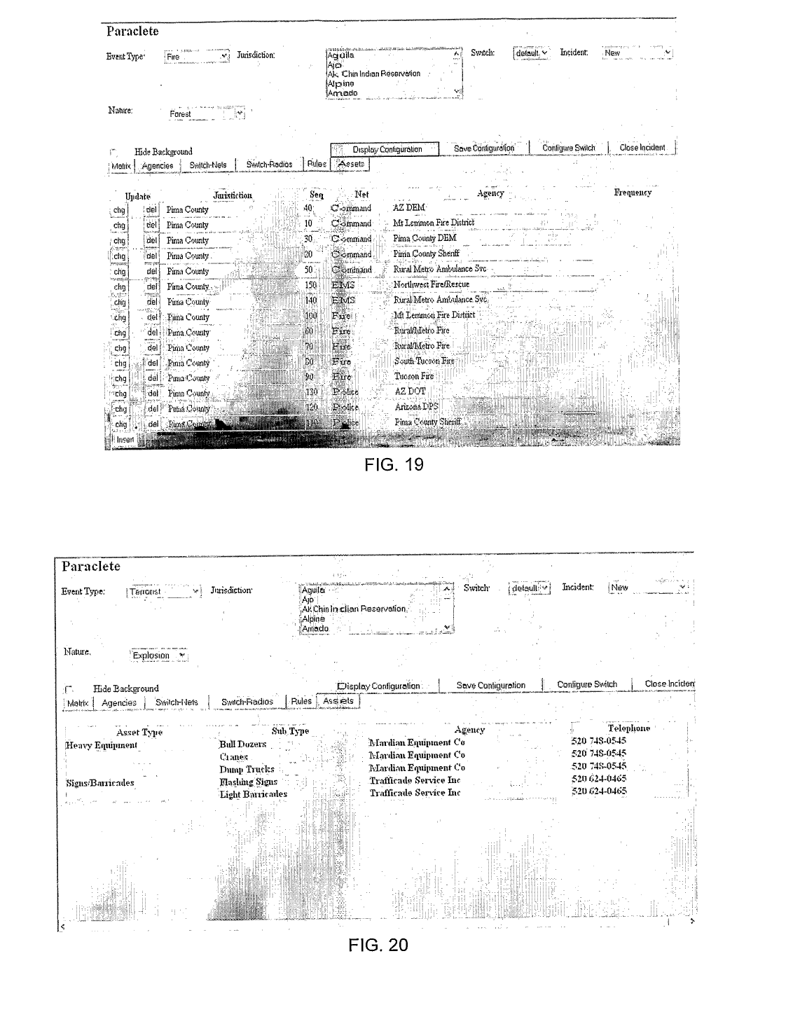

The Manage Local Rules transaction allows the user to view or modify rules for an event. Using the interface shown in FIG. 19 (which is displayed by selecting the Rules button), when a user is prompted to add or change a rule the system provides a selection of valid nets and Agencies. The agencies must exist and be valid for the jurisdiction. Requirement prevents the formation of an extremely large selection list for agencies. Using this transaction, rules can be set up by a local responsible agency.

According to a preferred embodiment, the database schema for this transaction is as follows:

1. Local_Rules (Keyed by Juristiction, EM_Key, and Seq)

| Name | Schema | Datatype | Size | Scale | Ref | Nulls? | Default Value |
|---|---|---|---|---|---|---|---|
| JURISTICTION | <None> | VARCHAR2 | 32 | | | | |
| EM_KEY | <None> | VARCHAR2 | 52 | | | | |
| SEQ | <None> | NUMBER | 4 | 0 | | | 0 |
| NET | <None> | VARCHAR2 | 20 | | | | |
| AGENCY | <None> | VARCHAR2 | 32 | | | ✓ | |
| SELECTED_F . . . | <None> | VARCHAR2 | 20 | | | ✓ | |
| FREQUENCY_ . . . | <None> | VARCHAR2 | 20 | | | ✓ | |
| TELEPHONE | <None> | VARCHAR2 | 20 | | | ✓ | |

### Maintain Local Asset Rules

When there is an emergency incident, there often is a need for additional assets, such as materials, supplies, vehicles, and the like. According to a preferred embodiment of the invention, a list of agencies that can provide such supporting, and related information, can be stored, modified and viewed. Referring to FIG. 20, when the “Assets” button is selected, the system displays the list of pertinent support agencies, the assets that they can provide and contact information including a telephone number. A given asset provider can be telephoned and connected to the switch 10 to communicate with the agencies that need the particular support.

The asset rules for a given event type, event nature and jurisdiction(s) can be entered into the system in advance so that contact information is available immediately when an emergency event occurs. The Maintain Local Asset Rules transaction allows the user to view or modify the asset requirement rules for an event, using the interface of FIG. 20 (with an Update section having “chg.” “del” and “insert” buttons, similar to that shown in FIG. 19). When a user is prompted to add or change a rule, the system will provide a selection of valid Nets and Agencies. Preferably, Agencies must exist and be valid for the jurisdiction. Requirement prevents the formation of an extremely large selection list for Agencies.

According to a preferred embodiment, the database schema for this transaction is as follows:

1. Local Assets (Keyed by Jurisdiction, EM_Key, and Seq)

| Name | Schema | Datatype | Size | Scale | Ref | Nulls? | Default Value |
|---|---|---|---|---|---|---|---|
| JURISDICTION | <None> | VARCHAR2 | 32 | | | | |
| EM_KEY | <None> | VARCHAR2 | 52 | | | | |
| SEQ | <None> | NUMBER | 4 | 0 | | | |
| ASSET_TYPE | <None> | VARCHAR2 | 20 | | | | |
| ASSET_SUB_TYPE | <None> | VARCHAR2 | 30 | | | ✓ | |
| AGENCY | <None> | VARCHAR2 | 32 | | | | |
| TELEPHONE | <None> | VARCHAR2 | 20 | | | ✓ | |

### Maintain Radio

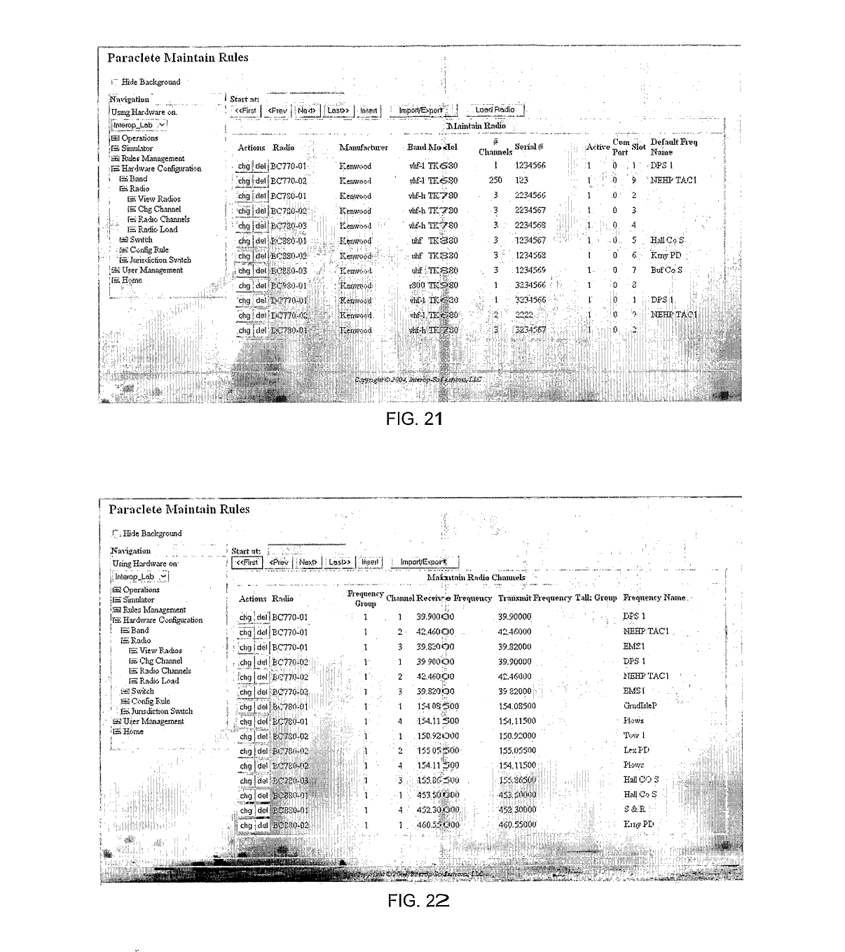

The Maintain Radio transaction allows the user to manage the definition of a radio. FIG. 21 shows an exemplary Maintain Rules screen displays for this purpose. With this transaction the user can set the range of frequencies and number of channels supported by the radio and the specific frequencies assigned to each available channel. The transaction also displays the status of the radio (Active=1/0) and its position (slot) in a switch as well as the comm-port used to connect the radio. The default frequency is the radio frequency that the radio will be set to when it is not active on an incident. The “Load Radio” button allows the communications engineer to specify a load to be put on a radio. By defining loads that are common by band on switch the management of radios is greatly simplified since every change need not be manually made to each radio on a switch.

According to a preferred embodiment, the database schema for this transaction is as follows:

1. Radio (Keyed by Radio_Id)

| Name | Schema | Datatype | Size | Scale | Ref | Nulls? | Default Value |
|---|---|---|---|---|---|---|---|
| RADIO_ID | <None> | VARCHAR2 | 20 | | | | |
| MANUFACTURER | <None> | VARCHAR2 | 32 | | | | |
| MODEL | <None> | VARCHAR2 | 20 | | | | |
| BAND | <None> | VARCHAR2 | 10 | | | | |
| CHANNELS | <None> | NUMBER | 4 | 0 | | | |
| SERIAL_NUMBER | <None> | VARCHAR2 | 32 | | | | |
| ACTIVE | <None> | NUMBER | 1 | 0 | | ✓ | |
| COMMPORT | <None> | NUMBER | 4 | 0 | | ✓ | |
| ACUSLOT | <None> | NUMBER | 4 | 0 | | ✓ | |
| DEFAULT_FREQ_NAME | <None> | VARCHAR2 | 20 | | | ✓ | |

### Maintain Radio Channels

The Maintain Radio Channels transaction shows the current channels available on each radio in the system. FIG. 22 shows an exemplary Maintain Rules screen displays for this purpose.

1. Radio Channels (Keyed by Radio_Id)

| Name | Schema | Datatype | Size | Scale | Ref | Nulls? | Default Value |
|---|---|---|---|---|---|---|---|
| RADIO_ID | <None> | VARCHAR2 | 20 | | | | |
| FREQUENCY_GROUP | <None> | NUMBER | 3 | 0 | | | |
| CHANNEL | <None> | NUMBER | 4 | 0 | | | |
| TRANSMIT_FREQUENCY | <None> | VARCHAR2 | 20 | | | | |
| RECEIVE_FREQUENCY | <None> | VARCHAR2 | 20 | | | ✓ | |
| TALK_GROUP | <None> | VARCHAR2 | 20 | | | ✓ | |

### Maintain Jurisdiction

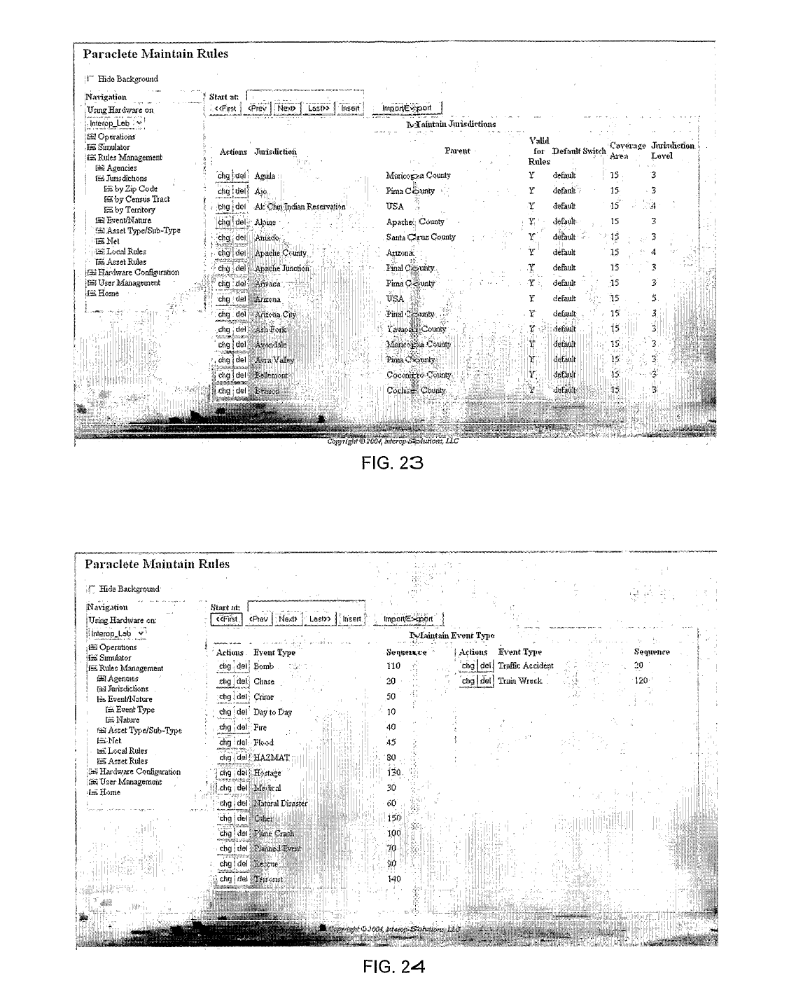

The Maintain Jurisdiction transaction allows the user to define Jurisdictions and their defaults. FIG. 23 shows an exemplary Maintain Jurisdiction screen displays for this purpose.

According to a preferred embodiment, the database schema for this transaction is as follows:

1. Juristiction (Keyed by Juristiction)

| Name | Schema | Datatype | Size | Scale | Ref | Nulls? | Default Value |
|---|---|---|---|---|---|---|---|
| JURISTICTION | <None> | VARCHAR2 | 32 | | | | |
| PARENT | <None> | VARCHAR2 | 32 | | | ✓ | |
| GOVERNANCE | <None> | VARCHAR2 | 20 | | | ✓ | |
| VALID_FOR_RULES | <None> | VARCHAR2 | 10 | | | ✓ | |
| OVERRIDE_KEYWORD | <None> | VARCHAR2 | 32 | | | ✓ | |
| OVERRIDE_AGENCY | <None> | VARCHAR2 | 32 | | | ✓ | |
| OVERRIDE_FREQ | <None> | VARCHAR2 | 20 | | | ✓ | |
| OVERRIDE_MUTUAL_AID | <None> | VARCHAR2 | 20 | | | ✓ | |
| OVERRIDE_FREQ_NAME | <None> | VARCHAR2 | 20 | | | ✓ | |
| OVERRIDE_MUTUAL_AID_NAME | <None> | VARCHAR2 | 20 | | | ✓ | |
| DEFAULT_SWITCH | <None> | VARCHAR2 | 20 | | | | |
| MAXMOBILEAREA | <None> | LONG | | | | ✓ | |

The Maintain Event Type transaction allows the user to define high level categories for classifying events. FIG. 24 shows an exemplary Maintain Rules screen display for this purpose.

According to a preferred embodiment, the database schema for this transaction is as follows:

1. Event_Type (Keyed by EventType)

| Name | Schema | Datatype | Size | Scale | Ref | Nulls? | Default Value |
|---|---|---|---|---|---|---|---|
| EVENTTYPE | <None> | VARCHAR2 | 32 | | | | |
| DEFAULT_IC | <None> | VARCHAR2 | 32 | | | ✓ | |
| PRIORITY | <None> | NUMBER | 2 | 0 | | | |
| MAGNITUDE_T . . . | <None> | VARCHAR2 | 20 | | | ✓ | |

### Maintain Nature

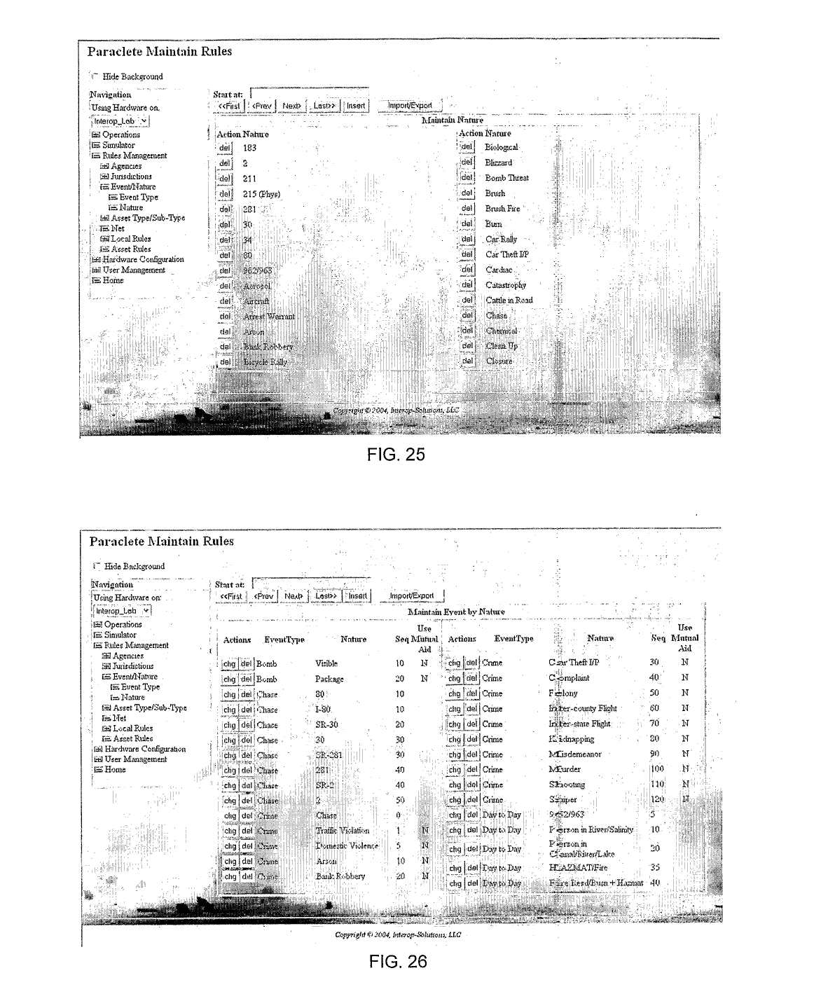

The Maintain Nature transaction allows the user to define the sub classifications of Event Type by type. FIG. 25 shows an exemplary Maintain Rules screen display for this purpose.

According to a preferred embodiment, the database schema for this transaction is as follows:

1. Magnitude (Keyed by Magnitude)

| Name | Schema | Datatype | Size | Scale | Ref | Nulls? | Default Value |
|---|---|---|---|---|---|---|---|
| MAGNITUDE | <None> | VARCHAR2 | 20 | | | | |

### Maintain Event by Nature

The Maintain Event by Nature transaction allows the user to associate Event Nature to Event Type. FIG. 26 shows an exemplary Maintain Rules screen display for this purpose.

According to a preferred embodiment, the database schema for this transaction is as follows:

1. Event_Nature (Keyed by EventType, Nature, Seq)

| Name | Schema | Datatype | Size | Scale | Ref | Nulls? | Default Value |
|---|---|---|---|---|---|---|---|
| EVENTTYPE | <None> | VARCHAR2 | 32 | | | | |
| MAGNITUDE | <None> | VARCHAR2 | 20 | | | | |
| SEQ | <None> | NUMBER | 4 | 0 | | | |
| USE_MUTUAL_AID | <None> | VARCHAR2 | 10 | | | ✓ | |

### Maintain Agency

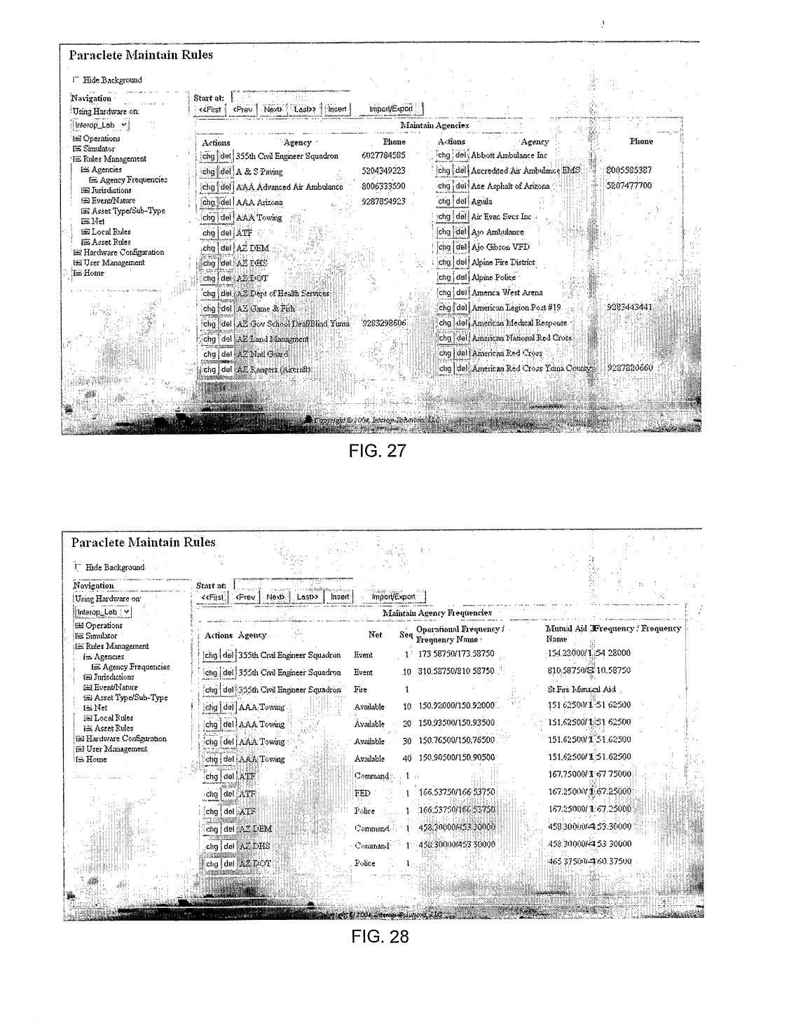

The Maintain Agency transaction allows the user to define the Agencies or Organizations that become involved in events. FIG. 27 shows an exemplary Maintain Rules screen display for this purpose.

According to a preferred embodiment, the database schema for this transaction is as follows:

1. Agencies (Keyed by Agency)

| Name | Schema | Datatype | Size | Scale | Ref | Nulls? | Default Value |
|---|---|---|---|---|---|---|---|
| AGENCY | <None> | VARCHAR2 | 32 | | | | |
| JURISDICTION | <None> | VARCHAR2 | 32 | | | | |
| SEQ | <None> | NUMBER | 4 | 0 | | | |

2. Agencies_by_jurisdiction (Keyed by Agency, Jurisdiction, Seq)

| Name | Schema | Datatype | Size | Scale | Ref | Nulls? | Default Value |
|---|---|---|---|---|---|---|---|
| AGENCY | <None> | VARCHAR2 | 32 | | | | |
| TELEPHONE | <None> | VARCHAR2 | 20 | | | ✓ | |

### Maintain Agency Frequencies

The Maintain Agency Frequencies transaction allows the user to manage the frequencies utilized by the agencies as they participate in respective nets. FIG. 28 shows an exemplary Maintain Rules screen display for this purpose.

According to a preferred embodiment, the database schema for this transaction is as follows:

1. Frequencies (Keyed by Agency, Net, Seq)

| Name | Schema | Datatype | Size | Scale | Ref | Nulls? | Default Value |
|---|---|---|---|---|---|---|---|
| AGENCY | <None> | VARCHAR2 | 32 | | | | |
| NET | <None> | VARCHAR2 | 20 | | | | |
| SEQ | <None> | NUMBER | 4 | 0 | | | |
| COMMAND_FREQ | <None> | VARCHAR2 | 20 | | | ✓ | |
| OPS_FREQ | <None> | VARCHAR2 | 20 | | | ✓ | |
| MUTUAL_AID | <None> | VARCHAR2 | 20 | | | ✓ | |
| COMMAND_FREQ_NAME | <None> | VARCHAR2 | 20 | | | ✓ | |
| OPS_FREQ_NAME | <None> | VARCHAR2 | 20 | | | ✓ | |
| MUTUAL_AID_FREQ_NAME | <None> | VARCHAR2 | 20 | | | ✓ | |

### Maintain Jurisdiction by Census Tract

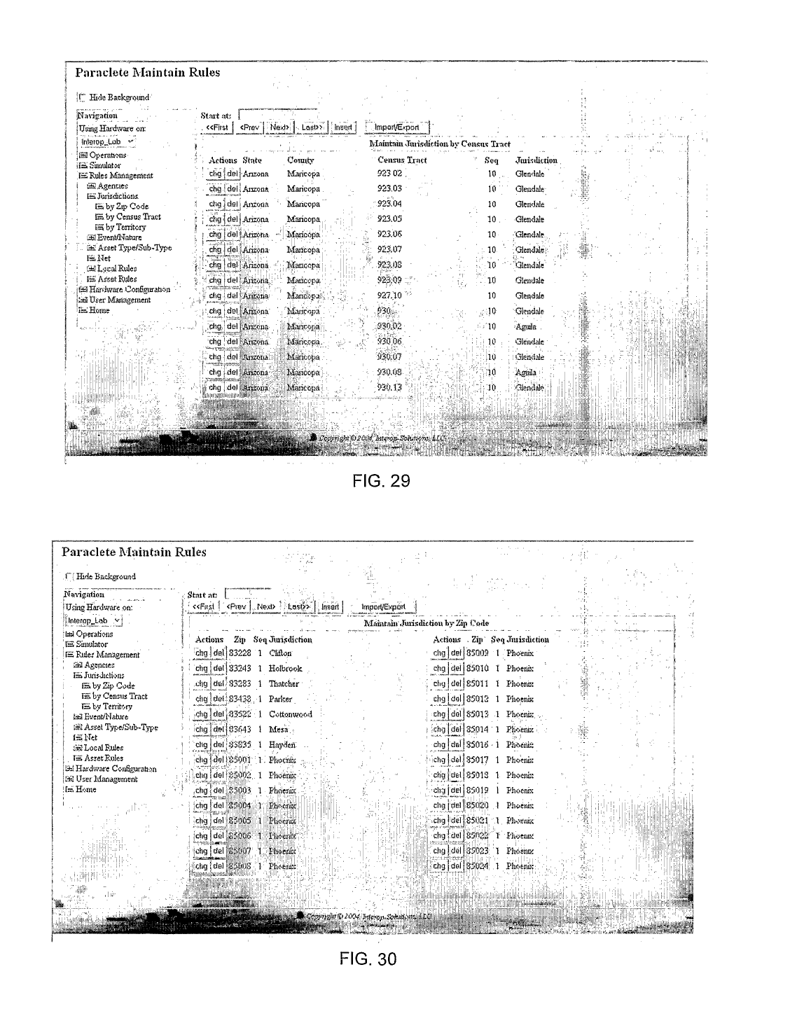

The Maintain Jurisdiction by Census Tract transaction allows a user to associate one or more jurisdictions to a census tract. FIG. 29 shows an exemplary Maintain Rules screen displays for this purpose.

According to a preferred embodiment, the database schema for this transaction is as follows:

1. CensusTract (Keyed by CensusTract, Seq)

| | | | | | | | |
|---|---|---|---|---|---|---|---|
| Name | Schema | Datatype | Size | Scale | Ref | Nulls? | Default Value |

| | | | | |
|---|---|---|---|---|
| CENSUSTRACT | <None> | VARCHAR2 | 20 | |
| SEQ | <None> | NUMBER | 0 | 0 |
| JURISTICTION | <None> | VARCHAR2 | 32 | |

### Maintain Jurisdiction by Zip Code

The Maintain Jurisdiction by Zip Code transaction allows the user to associate one or more jurisdictions to a zip code. FIG. 30 shows an exemplary Maintain Rules screen displays for this purpose.

According to a preferred embodiment, the database schema for this transaction is as follows:

1. Zip (Keyed by Zip, Seq)

| | | | | | | | |
|---|---|---|---|---|---|---|---|
| Name | Schema | Datatype | Size | Scale | Ref | Nulls? | Default Value |

| | | | | |
|---|---|---|---|---|
| ZIP | <None> | VARCHAR2 | 10 | |
| SEQ | <None> | NUMBER | 4 | 0 |
| JURISTICTION | <None> | VARCHAR2 | 32 | |

### Maintain Jurisdiction by Territory

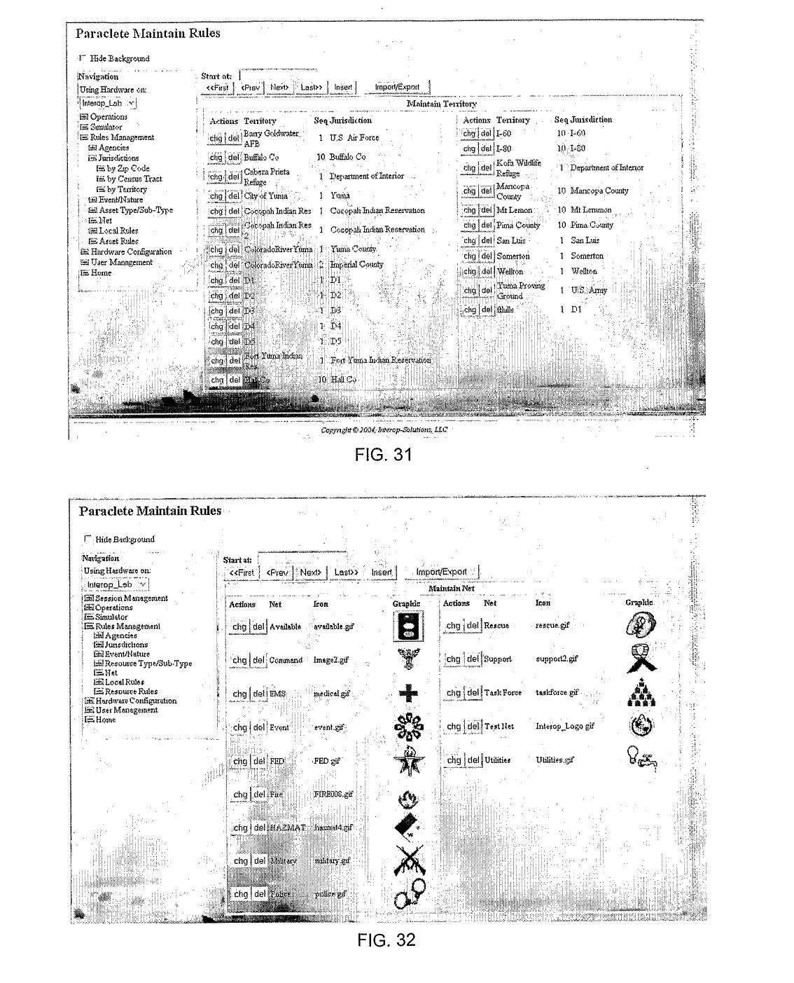

The Maintain Jurisdiction by Territory transaction allows the user to associate one or more jurisdictions to a Territory defined by shape on the map. FIG. 31 shows an exemplary Maintain Rules screen displays for this purpose.

According to a preferred embodiment, the database schema for this transaction is as follows:

2. Territory (Keyed by Territory, Seq)

| | | | | | | | |
|---|---|---|---|---|---|---|---|
| Name | Schema | Datatype | Size | Scale | Ref | Nulls? | Default Value |

| | | | | |
|---|---|---|---|---|
| TERRITORY | <None> | VARCHAR2 | 20 | |
| SEQ | <None> | NUMBER | 4 | 0 |
| JURRISTICTION | <None> | VARCHAR2 | 32 | |

### Maintain Net

The Maintain Net transaction allows the user to maintain the list of allowable nets to be used in switch configuration and rule specifications. FIG. 32 shows an exemplary Maintain Rules screen displays for this purpose.

According to a preferred embodiment, the database schema for this

1. Net (Keyed by Net)

| | | | | | | | |
|---|---|---|---|---|---|---|---|
| | | | | | | | Default |
| Name | Schema | Datatype | Size | Scale | Ref | Nulls? | Value |

| | | | | |
|---|---|---|---|---|
| NET | <None> | VARCHAR2 | 20 | |
| ICON | <None> | VARCHAR2 | 60 | ✓ |

### Maintain Band

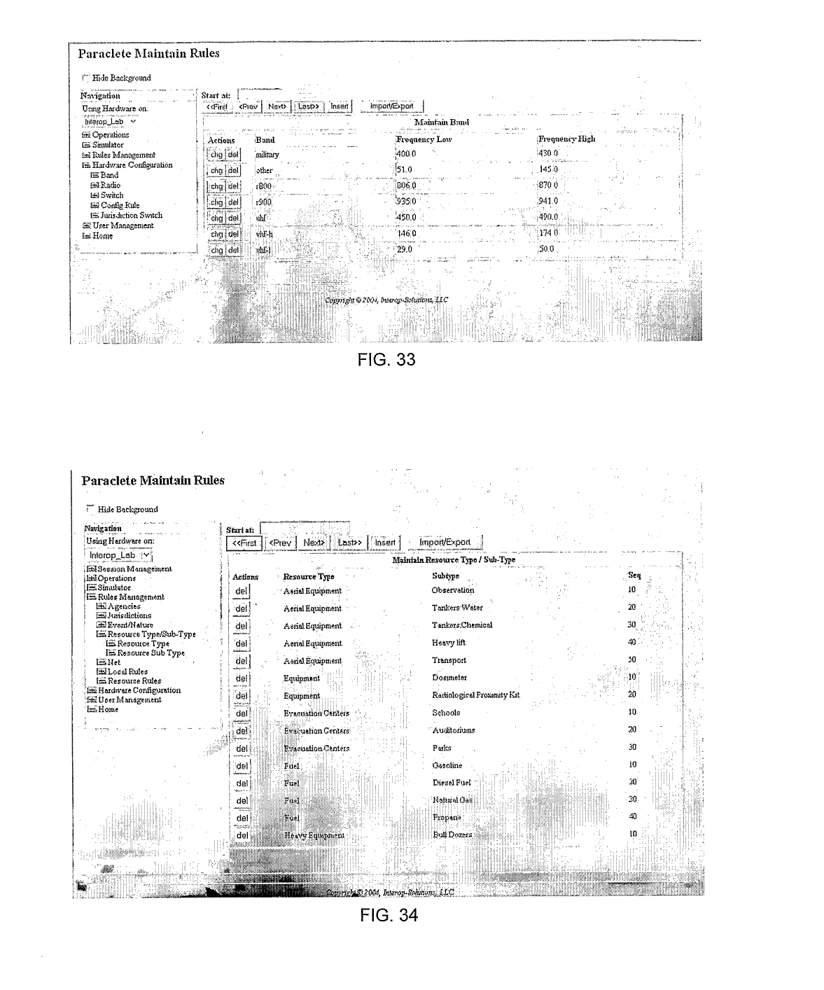

The Maintain Band transaction allows the user to maintain the list of allowable radio bands to be used in radio specifications. FIG. 33 shows an exemplary Maintain Rules screen displays for this purpose.

According to a preferred embodiment, the database schema for this transaction is as follows:

1. Band (Keyed by Band)

| | | | | | | | |
|---|---|---|---|---|---|---|---|
| Name | Schema | Datatype | Size | Scale | Ref | Nulls? | Default Value |

| | | | |
|---|---|---|---|
| BAND | <None> | VARCHAR2 | 10 |
| FREQUENCY_LOW | <None> | VARCHAR2 | 10 |
| FREQUENCY_HIGH | <None> | VARCHAR2 | 10 |

### Maintain Resource Type/Sub-Type

The Maintain Resource Type/Sub-Type transaction allows the user to maintain the valid combinations of types and subtypes that will be used for resource characterization. For example concrete and sand are valid subtypes for Materials while bulldozers and cranes are valid subtypes for Heavy Equipment. FIG. 34 shows an exemplary Maintain Rules screen displays for this purpose.

According to a preferred embodiment, the database schema for this transaction is as follows:

1. Asset_Type_Subtype (Keyed by Asset_Type, Asset_Subtype, Seq)

| | | | | | | | |
|---|---|---|---|---|---|---|---|
| Name | Schema | Datatype | Size | Scale | Ref | Nulls? | Default Value |

| | | | | |
|---|---|---|---|---|
| ASSET_TYPE | <None> | VARCHAR2 | 20 | |
| SUBTYPE | <None> | VARCHAR2 | 30 | |
| SEQ | <None> | NUMBER | 4 | 0 |

### Maintain Resource Type

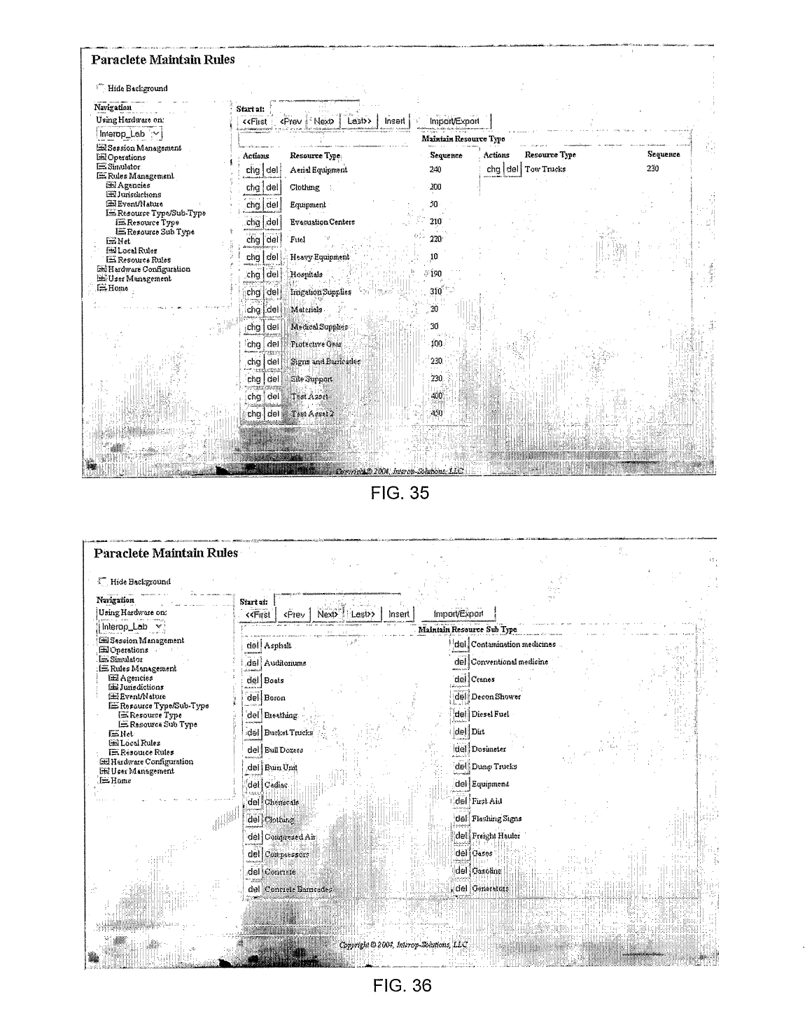

The Maintain Resource Type transaction allows the user to maintain the list of allowable resource types to be used for resource characterization. FIG. 35 shows an exemplary Maintain Rules screen display for this purpose.

According to a preferred embodiment, the database schema for this transaction is as follows:

1. Asset_Type (Keyed by Asset_Type)

| | | | | | | | |
|---|---|---|---|---|---|---|---|
| Name | Schema | Datatype | Size | Scale | Ref | Nulls? | Default Value |

| | | | |
|---|---|---|---|
| ASSET_TYPE | <None> | VARCHAR2 | 20 |

### Maintain Resource Sub-Type

The Maintain Resource Sub-Type transaction allows the user to maintain the list of allowable subtypes to be used in resource characterization. FIG. 36 shows an exemplary Maintain Rules screen display for this purpose.

According to a preferred embodiment, the database schema for this transaction is as follows:

1. Asset_Subtype (Keyed by Subtype

| | | | | | | | |
|---|---|---|---|---|---|---|---|
| Name | Schema | Datatype | Size | Scale | Ref | Nulls? | Default Value |

| | | | |
|---|---|---|---|
| SUBTYPE | <None> | VARCHAR2 | 30 |

Change Control

In a preferred embodiment, the system of the preset invention is designed to be additive and “full disclosure” in nature. That is to say that once an event has occurred of a particular Type and Nature, then that Type and Nature cannot be deleted from the system. By the same token once an Agency has been involved in an event its interaction in the event cannot be removed from the system. Changes to the system will be logged by date/time, user ID, and machine IP address.

Security

In a preferred embodiment, the system of the preset invention is capable of being operated over the Internet. It can provide the ability to manage a switch at a remote site but at the same time it can be secured to insure that only authorized personnel can view and or change the setting on emergence communications equipment. Access to the interoperability program can be over SSL or VPN and can use suitable security mechanisms known in the art.

### OVERVIEW OF EXAMPLES

Further details of the operation of a preferred system of the invention can be seen from the following examples of public safety event scenarios. PSWN (Public Safety Wireless Network) describes “Interoperability” as “the combining of multiple agencies with multiple communications infrastructures into a prescribed communications environment to achieve predictable results.” Without a prescribed communications environment and an understanding of the predicted results, interoperability will not work. The scenarios included are chosen to reflect a mix of complex and day to day scenarios.

There are many agencies, and jurisdictions included. These agencies and jurisdictions have radio systems with multiple frequencies licensed to them. We have arbitrarily selected frequencies either from the frequencies licensed to the agencies or from the federal and state interagency pool of frequencies to support the communications plan. We have entered multiple frequencies for agencies to support simultaneous events. Every attempt has been made to make the scenarios as realistic as possible. Several agencies within the state of Arizona have been consulted to insure the accuracy of the scenarios.

### Example Scenario #1

### Federal Drug Bust with Support from Local Agencies

This scenario highlights the use of the solution as a location driven device. Traditionally the solution separates networks by function (i.e. a police net, a fire net and an EMS net) In this case, DEA would be directing multiple agencies entering multiple sites simultaneously. This would be done to maintain the element of surprise at each location. In order to accomplish this, all the agencies would need to communicate throughout the event. The city of Marana is located approximately 20 miles from Downtown Tucson, and about 15 miles from Oro Valley. This communication can be accomplished through Paraclete and the ACU1000 by utilizing the following frequencies:

| | Primary | Alternate |
|---|---|---|
| (Marana Network #2) | | |
| DEA | 165.2350 Simplex | 418.8250/415.6000 |
| Pima Co. Sheriff | 866.5125 Simplex # | 860.1000/815.1000 |
| Marana PD | 866.5125 Simplex # | 855.9625 Simplex |

# 800 MHz Inter-Agency
2 Radios used in Primary
3 Radios used in Alternate

| | | |
|---|---|---|
| (Oro Valley Network #3) | | |
| DEA | 167.7500 Simplex | 419.2500 Simplex |
| Pima Co. Sheriff | 866.0125/823.0125 | 860.1000/815.1000 |
| Oro Valley PD | 460.3750 Simplex | 453.3500/458.3500 |

3 Radios used in Primary and Alternate

| | | |
|---|---|---|
| (Tucson Network #4) | | |
| DEA | 167.0875 Simplex | 418.0500 Simplex |
| Pima Co. Sheriff | 867.0125/822.0125 | 860.1000/815.1000 |
| Tucson PD | 155.4750 Simplex | 155.3100/158.8050 |

3 Radios used in Primary and Alternate

The frequencies listed above would be the communications used at each individual site. The officers actually performing the bust would use these frequencies to communicate with each other at the site. Since tying several separate operational channels together over the entire Tucson metropolitan area would render those channels useless for normal communications traffic, a “Command Network” will use the following Inter-Agency frequencies for coordination of the event:

| (Command Network #1) | Primary |
|---|---|
| DEA | 167.4500 Simplex |
| Pima Co. Sheriff | 868.0125/823.0125 Simplex |
| Marana PD | 868.0125/823.0125 Simplex |
| Oro Valley PD | 453.4750/458.4750 |
| Tucson PD | 154.7250/158.8000 |

4 Radios used

In this configuration, only DEA, and Oro Valley are using operational channels. DEA has several channels to choose from and could clear normal traffic to other channels. Oro Valley is utilizing their SWAT channel, which is reserved for events of this nature.

During this operation, the Incident Commander at each location would be required to use 2 radios. One radio would be used to communicate with the other team members at the individual site, while the other radio would be used to communicate with the “Command Network”.

As can be seen in the scenario's communication plan, there are alternate frequencies established so that if another event were to take place within radio range of this event, Paraclete would have alternate frequencies to use to support the other event. The alternate frequencies can also be used if this event was established after another event that was already using the primary frequencies.

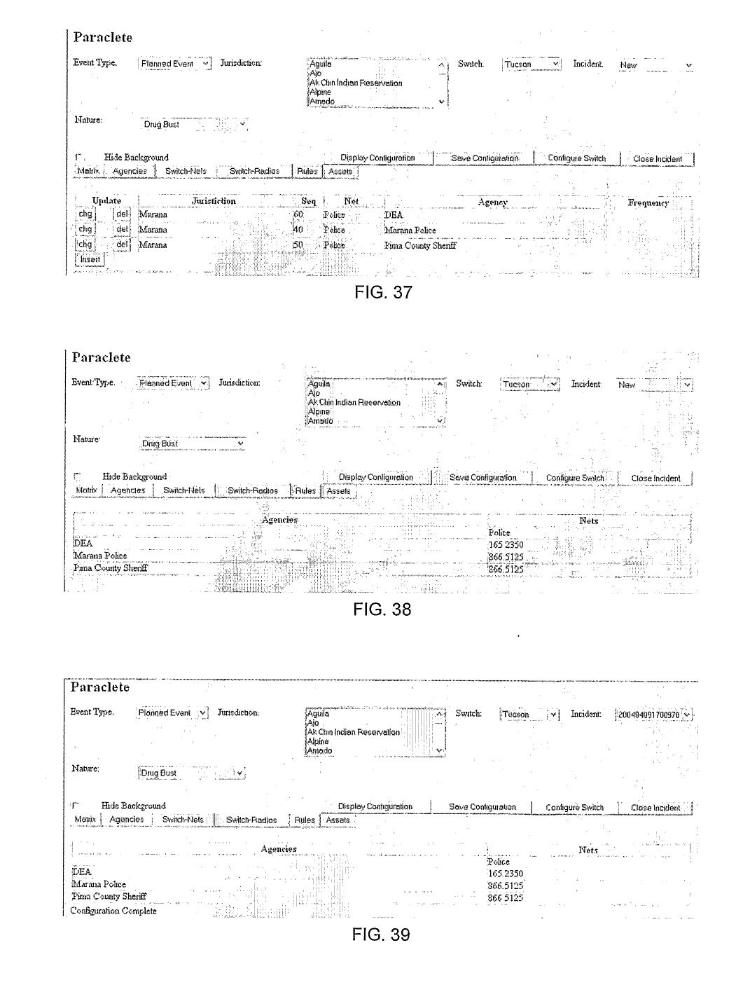

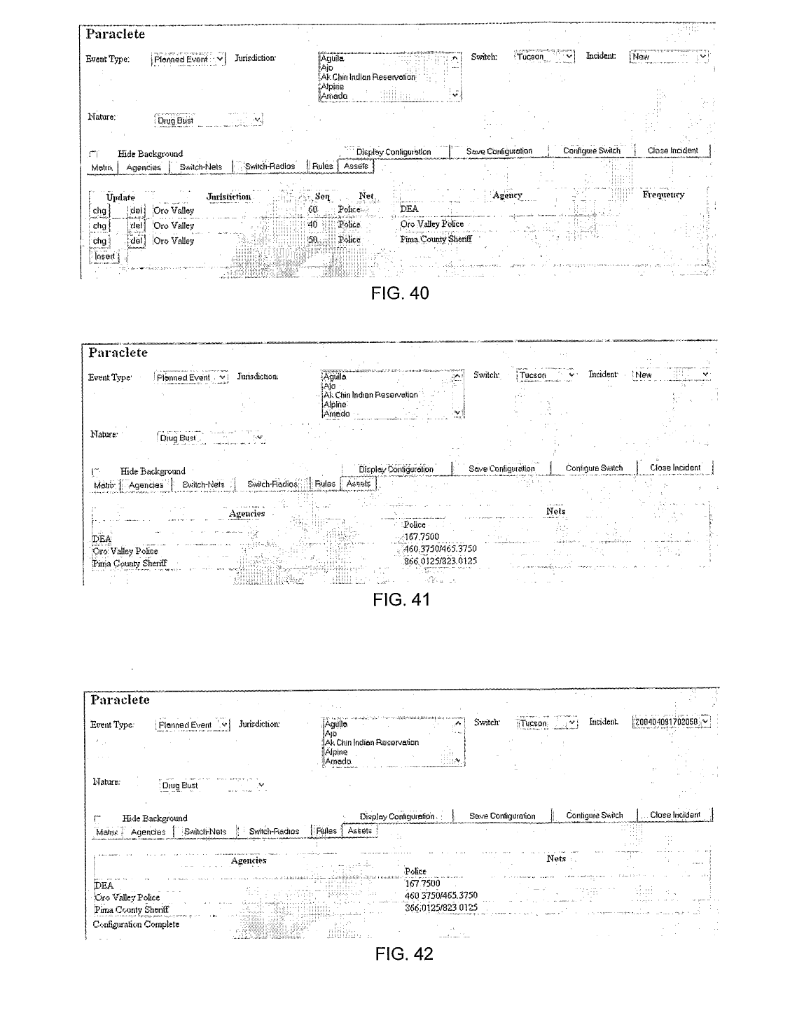

FIGS. 37-52 show screen displays for Example Scenario #1. Rule configuration is shown in FIG. 37. The rule simply specifies who participates in a drug bust: (DEA, Pima County Sheriff, and the local police.) When the event is entered, the system looks up the agencies and selects the appropriate frequency based on the available frequencies for the agency (see FIG. 38). When the user clicks on the “Display Configuration” button the display of FIG. 38 results showing the configured frequencies. When the dispatcher clicks the “Save Configuration” button the configuration is logged (see FIG. 39), and the dispatcher may then opt to configure the switch. The equivalent displays for Oro Valley are shown in FIGS. 40-42.

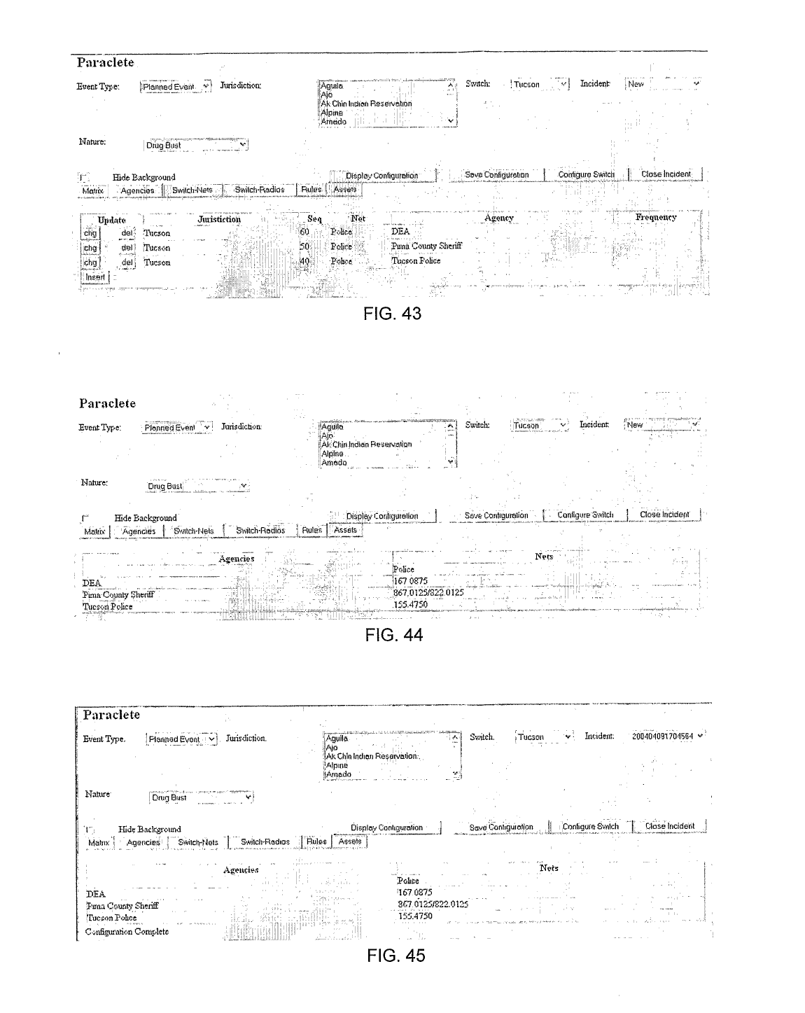

The rules, initial configuration and switch configuration for Tucson are shown in FIGS. 43-45. Note that the system knows the location of each incident and since the incidents are within radio coverage of each other the system does not re-use the same frequencies. It checks the maximum coverage area for each involved jurisdiction and picks the largest. It then checks the distances to each active incident and uses the alternate frequencies rather than double up a frequency (which could be fatal to a bystander or officer).

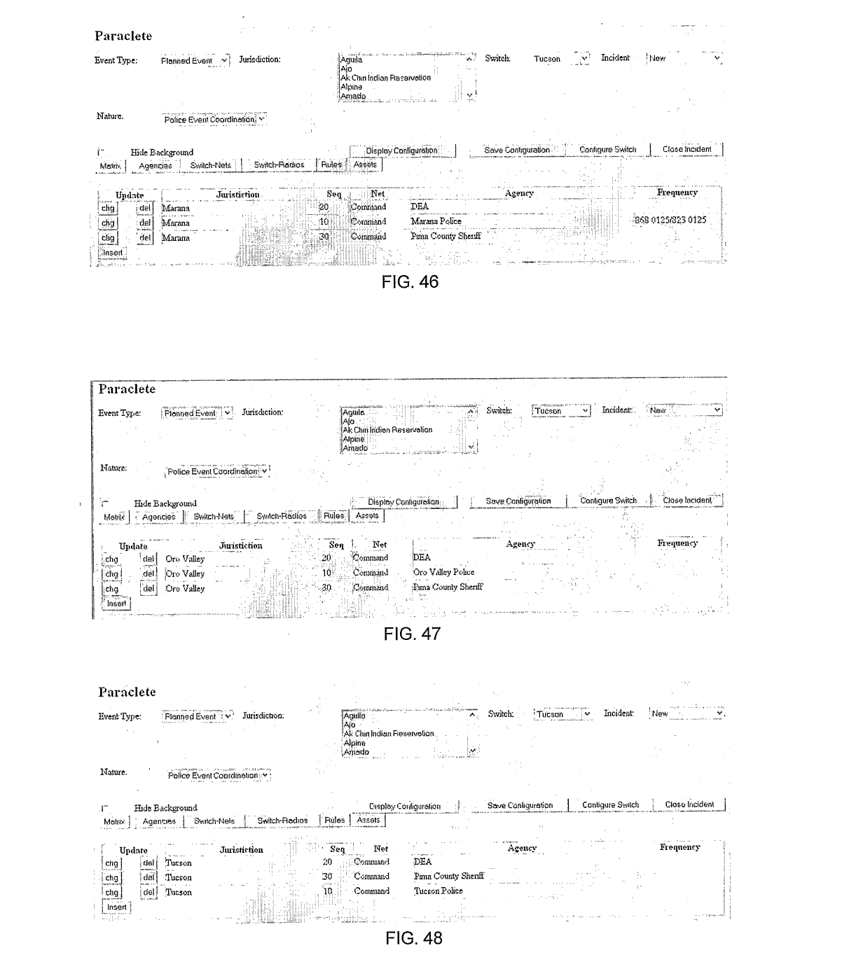

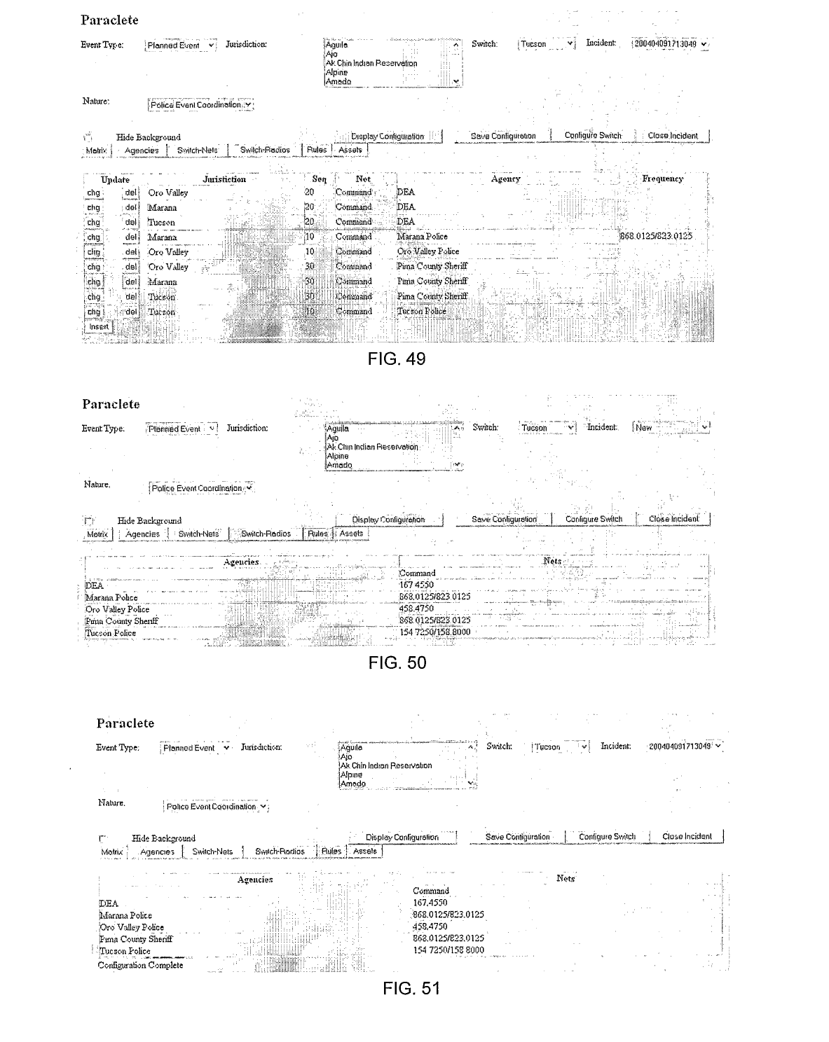

The synchronized sting is configured as a “Planned Event”+“Police Event Coordination.” The displays of FIGS. 46-49 show the result of combining the individual jurisdiction rules (Marana, Oro Valley, and Tucson). Each individual jurisdiction has rules as shown in FIGS. 46-48. Note that Marana has opted to override their default command frequency and utilize the Mutual Aid frequency that the Sheriff will be using. These individual rules combine automatically when the event is configured with each of the jurisdictions, as shown in FIG. 49. When the event is scheduled the dispatcher selects the locations on the map and then selects the “Planned Event”+“Drug Bust” for each individual location. The individual rule sets precede each event entry. The rules for the drug bust are shown in FIGS. 50 and 51.

At this point the switch is providing connectivity for each entry team. It is also providing a command net to allow the synchronizations of entry at all three sites (see FIG. 52). Note that each radio is marked with the event id it is currently supporting. The “del” function allows the dispatcher to drop a radio from an event. For example APS was provided coverage during a fire but once the power has been cut APS leaves the scene and the radio can be freed. The insert function allows an additional unused radio to be added to an incident. If an unplanned agency becomes involved or an individual unit does not have the required frequency on a radio. The chg function allows the dispatcher to change the frequency on a radio.

### Example Scenario #2

### Explosion at Tucson International Airport

In this scenario, an explosion occurs aboard an aircraft parked at the terminal at Tucson International Airport. The explosion is caused by a premature detonation of a terrorist bomb placed in the aircraft's cabin during boarding. The resulting explosion ignites the fuel onboard the aircraft, as well as causing the collapse of the end of the terminal building. The burning fuel travels to an adjacent aircraft and causes it to explode. The resulting damage from the two exploded aircraft and collapsed building includes 200 dead, 150 injured and a major fuel fire. This scenario would involve approximately twenty-one separate agencies. This fact will cause the use of at least two ACU1000s to support communications. The agencies would be separated into networks according to their function. The following is a list of those agencies, the networks they would be grouped in and the frequencies used to communicate:

| | Primary | Alternate |
|---|---|---|
| Command Network #1 | | |
| Tucson Intrl Airport F D | 868.0125/823.0125 # | |
| Pima Co. Sheriff's Dept | 868.0125/823.0125 # | |
| Pima Co. Emerg. Man. | 868.0125/823.0125 # | |
| Rural Metro (EMS) | 154.3700 Simplex | |
| FBI | 167.7500 Simplex \hat{ } | |
| FEMA | 167.7500 Simplex \hat{ } | |
| \hat{ } Federal Interoperability Channel | | |
| # 800 MHz Inter-agency Channel | | |
| 3 Radios Used | | |
| Fire Network #2 | | |
| Tucson Fire Department | 453.2500 | 453.3250 Simplex |
| South Tucson Fire Department | 154.2800* | 154.2200/151.1150 |
| Northwest Fire Department (Fire) | 154.2800* | 153.9500 Simplex |
| Rural/Metro Fire Department (Fire) | 154.2800* | 154.4000 Simplex |
| Air National Guard Fire Department | 164.7000 | 166.2250 Simplex |
| Davis-Monthon AFB Fire Department | 154.2800* | 413.2000/407.3750 |
| *AZ State Fire Mutual Aid Channel | | |
| 3 Radios Used in Primary | | |
| 6 Radios used in Alternate | | |
| Law Enforcement Network #3 | | |
| Transportation Security Administration | 172.1500 Simplex | No Alt Listed |
| Tucson Police Department | 155.4750 Simplex #@ | 155.3100/158.8050 |
| South Tucson Police Department | 155.4750 #@ | 155.9550 Simplex |
| Tucson International Airport Police | 866.5125 | 859.2500/814.2500 |
| AZ Department of Public Safety | 460.3750/465.3750 @ | 460.2250/465.2250 |
| Pima County Sheriff | 866.5125 @ | 860.1000/815.1000 |

# AZ Law Enforcement Inter-Agency
@ Tri-Band System
3 Radios Used in Primary
6 Radios Used in Alternate
@ Pima County owns a Tri-Band Repeater System that can support 1 VHF, 1 UHF and
1 800 MHz frequency tied together.

| | | |
|---|---|---|
| Federal Network #4 | | |
| FBI | 167.2500 & | 163.9375/167.4875 |
| BATF | 167.2500 & | 166.5375 |
| NTSB | 167.2500 & | 162.2625/167.2500 |
| FAA | 167.2500 & | 172.9500 |
| FEMA | 167.2500 & | 164.8625 |

& Federal Interoperability Channel
Federal Network #4 established for inter-connect to other
networks or if Federal Interoperability Channel is not available.
5 Radios Used in Alternate

| | | |
|---|---|---|
| Emergency Medical Services Network #5 | | |
| Pima County Health Services | 856.2000 Trunked | 856.1250 Trunked |
| Tucson Fire Department (Ambulances) | 463.0000/468.0000% | 453.2500 Simplex |
| Rural/Metro (Ambulances) | 463.0000/468.0000% | 154.3700/153.8900 |
| Northwest Fire (Ambulances) | 463.0000/468.0000% | 453.2500 Simplex |
| % EMSCOM Channel | | |

2 Radios Used in Primary
4 Radio used in Alternate

This scenario involves at least 11 separate radio channels. If only the Primary channels could be used, this scenario would be supported with 1 ACU1000. If the Federal Interoperability channels were not usable, the number of required radios would increase to over 15. This number could be supported by (2) ACU1000s. Paraclete will support the use of several ACU1000s simultaneously; therefore, 2 ACU1000s can be successfully used to support this event.

In the event that multiple ACU1000s are used, it becomes necessary to tie the switches together physically to support controlling the devices. This physical connection can be achieved through Wide Area Networks or the use of wireless means like a 80211.g “Hot Spot. The 2 devices must also share RF connection by means of matching frequencies within the Networks. An example of this can be accomplished by using the same radio frequency in each network on the “Pima County” Switch as is used for the “Tucson” Switch (i.e. the 2 Fire

Networks would both have a radio tuned to 154.2800 State Fire Mutual Aid).

The networks would have to be set-up with Network #1, #2 and #3 in ACU1000 #1 (9 Radios Used), Networks #4 and #5 in ACU1000 #2 (possibly 7-11 Radios Used). This configuration allows for expansion of all of the Networks if the need should arise.

Paraclete is capable of controlling both fixed and mobile ACU1000s. In this case, there would be a fixed ACU1000 at the Pima Co. Sheriff's Dispatch Center, another fixed ACU1000 at the airport and if need be a mobile ACU1000 in the Tucson Fire Department Battalion Vehicle with a 80211.g “Hot Spot” that could wirelessly connect to the Internet through a “Hot Spot” at the airport.

@ It is possible to use Pima County's “Tri-Band” repeater system to tie the Law Enforcement radios together. This would facilitate the use of (2) ACU1000s, but would leave no room for expansion.

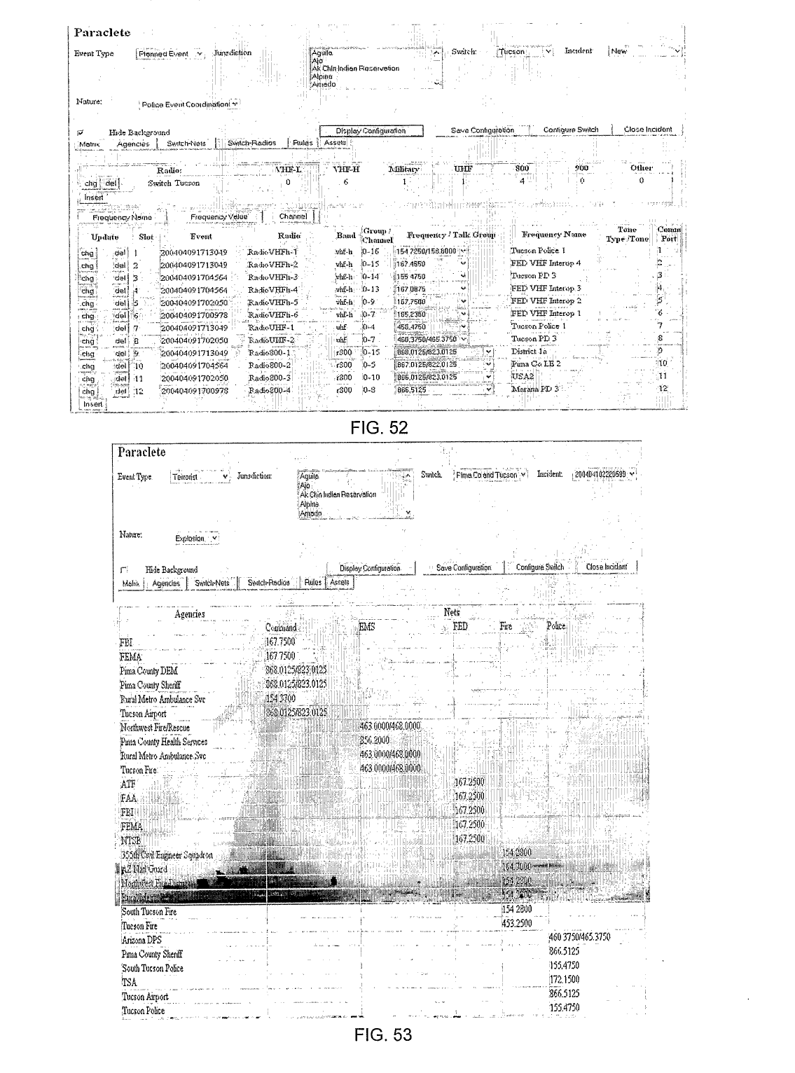

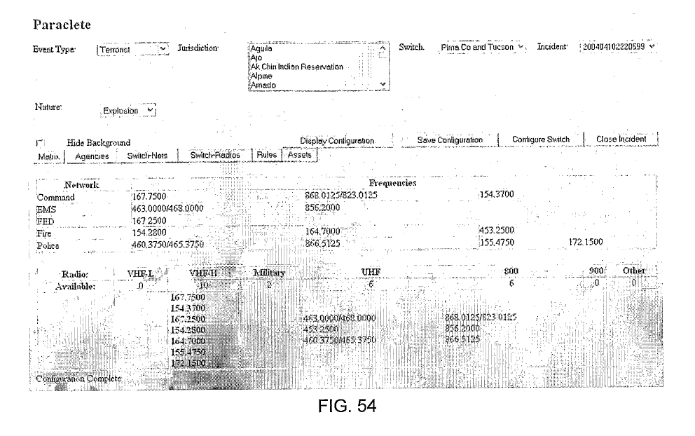

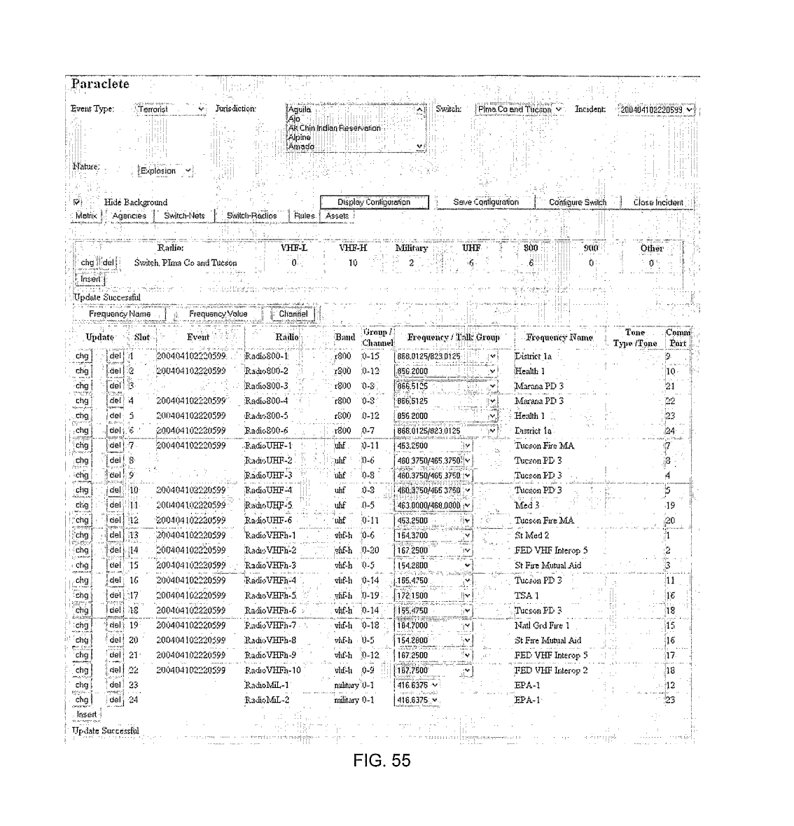

FIGS. 53-55 show screen displays for Example Scenario #2. As can be seen in the sceriario's communication plan, there are alternate frequencies established so that if another event were to take place within radio range of this event, the system would have alternate frequencies to u se to support the other event. The alternate frequencies can also be used if this event was established after another event that was already using the primary frequencies.

### Example Scenario #3

### Wild Land/Forest Fire on Mt. Lemmon

A fire is caused by a lightening strike on Mt. Lemon between Soldier Camp and Summer Haven. This fire spreads to the west, down the mountain into extremely rugged terrain. The remote nature of the fire allows it to spread quickly to over several thousand acres. The large perimeter of the fire requires several Fire Departments to respond. It also requires the blocking of the only road into the effected area to reduce the danger to civilians. Pima County Sheriff's Office personnel must evacuate the towns of Soldier Camp and Summer Haven, as well as securing the road to outside traffic. Once the road is initially secured, Arizona State Department of Transportation must install more permanent barricades. These barricades must be manned to restrict the flow of traffic to only Fire, Law Enforcement Officers and EMS units. The Arizona Department of Public Safety (DPS) may become involved to restrict traffic coming off the freeway. They would not be used to assist in the evacuation or road closure due to the fact that the roads leading to and going up the mountain are county roads and therefore not in part of DPS's jurisdiction. The following is a list of the agencies that would be involved, the networks they would be grouped in and the frequencies used to communicate:

| | Primary | Alternate |
|---|---|---|
| Command Network #1 | | |
| Mt. Lemmon Fire District | 460.6375 | |
| Pima County Sheriff | 864.1000/819.1000 | |
| Pima County Emergency Management | 868.0125/823.0125 | |
| Arizona Dept. of Emergency Management | 147.3000 | |
| Rural/Metro Fire (EMS) | 154.4000 | |
| 5 Radios used in Primary or Alternate | | |
| Fire Network #2 | | |
| Rural/Metro (Fire) | 154.2800* | 154.4000 Simplex |
| Northwest Fire (Fire) | 154.2800* | 153.9500 Simplex |
| South Tucson Fire Department | 154.2800* | 154.2200/151.1150 |
| Tucson Fire Department | 453.2500 | 453.3250 Simplex |
| Mt Lemmon Fire District | 460.6000/465.6000 | 460.6375 Simplex |
| *AZ State Fire Mutual Aid | | |
| 3 Radios used in Primary | | |
| 5 Radios used in Alternate | | |
| Law Enforcement Network #3 | | |
| Pima County Sheriff | 866.0125/821.0125 | 867.0125/822.0125 |
| AZ Dept. of Public Safety | 460.2250/465.2250 | 460.4250/465.4250 |
| AZ Dept. of Transportation | 156.1050/151.0700 | 156.1350/151.1000 |
| 3 Radios used in Primary and Alternate | | |
| EMS Network #4 | | |
| Rural/Metro (EMS) | 154.3700 | 154.3700/153.8900 |
| Northwest Fire (EMS) | 154.2500 | 153.9500 Simplex |
| 2 Radios used in Primary and Alternate | | |

This scenario requires 12 modules be used in the ACU1000. This is the normal full compliment of radio modules for (1) ACU1000. In this scenario, each of the “Sector” or “Division” Chiefs (Fire, Law Enforcement, EMS) would be required to carry (2) radios. One radio would be set to a frequency within their network. The other radio would be set to the Command Network.

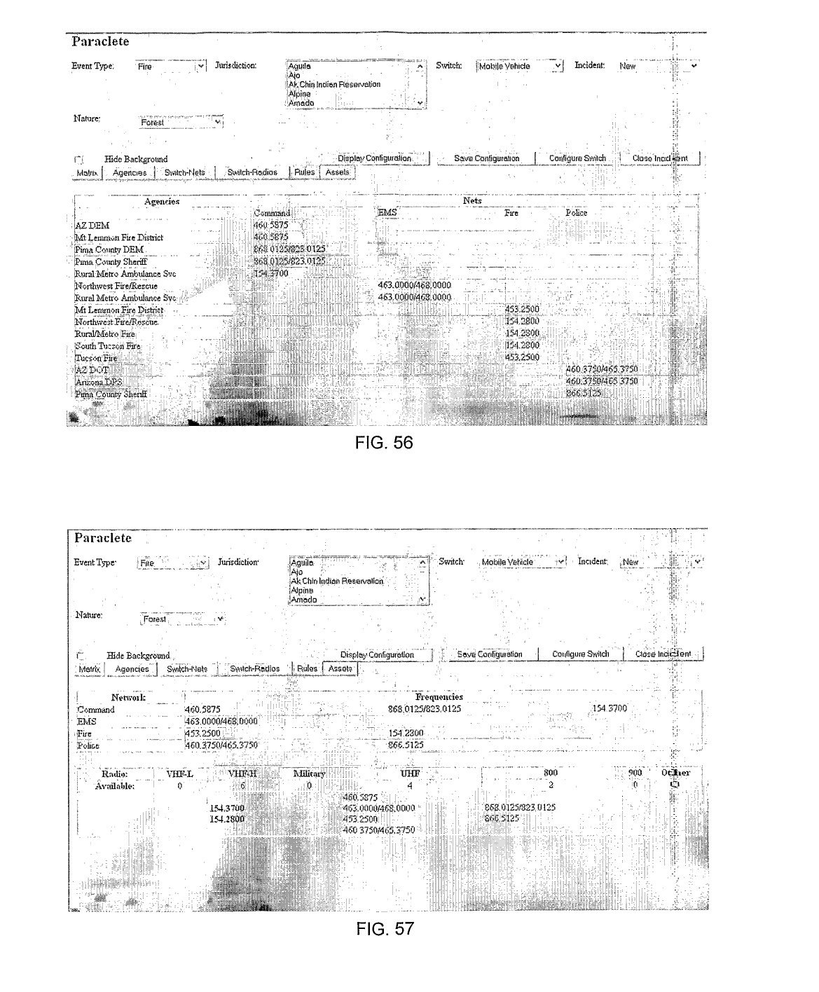

FIGS. 56-59 show screen displays for Example Scenario #3. As can be seen in the scenario's communication plan, there are alternate frequencies established so that if another event were to take place within radio range of this event, the system would have alternate frequencies to use to support the other event. The alternate frequencies can also be used if this event was established after another event that was already using the primary frequencies. The Command Network frequencies do not need alternates because the system sees these frequencies as “Command” assets as opposed to “Operations” assets and does not require a secondary frequency to go to (see FIG. 56).

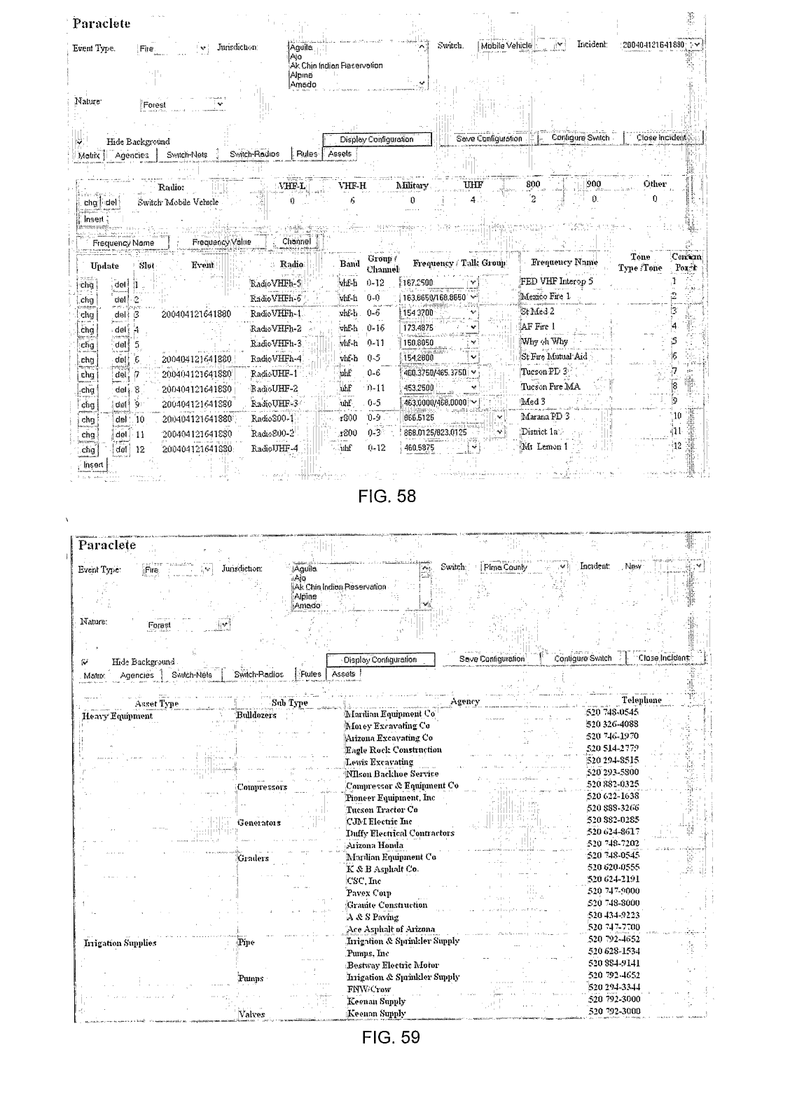

In the event that multiple ACU1000s are used, it becomes necessary to tie the switches together physically to support controlling the devices. This physical connection can be achieved through Wide Area Networks or the use of wireless means like a 80211.g “Hot Spot. The 2 devices must also share RF connection by means of matching frequencies within the Networks. As shown in FIGS. 57 and 58, an example of this can be accomplished by using the same radio frequency in each network on the “Pima County” Switch as is used for the “Tucson” Switch (i.e. the 2 Fire Networks would both have a radio tuned to 154.2800 State Fire Mutual Aid).

Another feature of system is the “Assets” button. Selecting this function will provide a list of all agencies that could support this event (see FIG. 59). This support can come in the form of material, equipment, supplies, vehicles, etc. As can be seen in the example, when the “Assets” button is activated, a list of all pertinent support agencies, and what support they provide is shown. Selecting a given agency will show contact information for that agency and provide a method to contact that agency by e-mail and emergency pager. A predetermined message with appropriate information about the event and contact information for the initiator will be sent to that agency's emergency paging system. This function will reduce the time necessary to convey vital communications information to each of the agencies involved.

### Example Scenario #4

### Traffic Accident (Tanker Spill) on Interstate-19, Seven Miles South of Tucson

This scenario involves a tanker spill on a State highway that causes bulk dirty oil to be spilled onto the Southeast corner of the Tohono O'odham Indian Nation. In this case, the west side of the road belongs to the Indian Nation and the east side of the road belongs to Pima County and the highway itself is the jurisdiction of the Arizona Department of Public Safety (Highway Patrol). The only nearby agency with HAZMAT control capability is the City of Tucson's Fire Department. The tanker Spill is caused by a collision between the tanker and an SUV that looses control directly in front of it. Both the tanker driver and the SUV driver are injured in the collision, prompting Rural/Metro to send fire units and ambulances to the scene. The bulk oil catches fire from the hot exhaust pipes of the tanker. The fire causes the need for both Tucson Fire Department and South Tucson Fire to respond. The spill on the highway causes DPS to close the South-bound Side of the Highway. The following is a list of the agencies that would be involved, the networks they would be grouped in and the frequencies used to communicate.

| | | |
|---|---|---|
| Event Network #1 | Primary | Alternate |

| | |
|---|---|
| Arizona Department of Public Safety | 460.2250/465.2250 |
| Tohono O odham Tribal Police | 170.1250/164.9625 |
| Pima County Sheriff | 866.0125/821.0125 |
| Tucson Fire Department | 453.2500 |
| South Tucson Fire Department | 154.2800* |
| Rural Metro (Fire) | 154.2800* |
| Rural/Metro (EMS) | 154.3250/153.9050 |

*State Fire Mutual Aid Channel

The ACU1000 used in this scenario would be located at the Pima County Sheriff's Dispatch Center. In this case, 6 radios were used to support the Network. This configuration only used 1 Network. This would be sufficient due to the limited time frame needed to support this event and the fact that all the frequencies used are considered either mutual aid channels or the agencies have multiple channels and normal traffic could be cleared to those other channels.

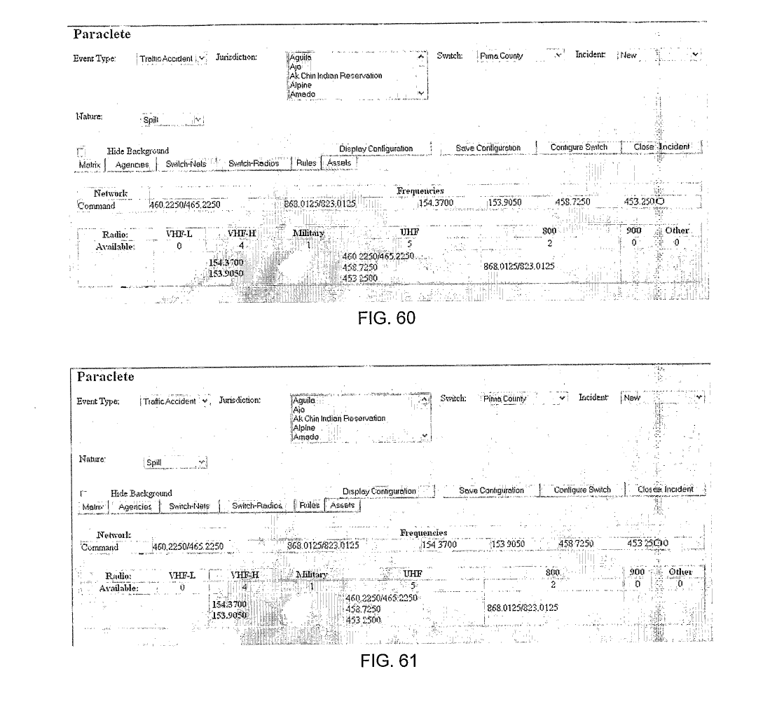

FIGS. 60-62 show screen displays for Example Scenario #4. As can be seen in the scenarios communication plan, there are alternate frequencies established so that if another event were to take place within radio range of this event, the system would have alternate frequencies to use to support the other event. The alternate frequencies can also be used if this event was established after another event that was already using the primary frequencies.

### Example Scenario #5

### Passenger Train Wreck at Interstate-10, North of Ajo Way in Downtown Tucson

In this scenario, a passenger train coming into the Tucson Terminal is derailed by missing section of track. This causes 2 passenger cars to derail and roll over. The remainder of the cars are stuck under the I-10 over pass and block 36^{th} St. The dubious nature of the derailment forces the FBI to respond and order the closure of I-10 for ½ mile either side of the train. This requires DPS and Arizona Dept. of Transportation to respond. The blockage of 36^{th} St causes Tucson Police Department to respond to re-route traffic. Pima County Sheriff's Deputies respond to support the Tucson Police Department. Rural/Metro, Tucson Fire Department and Northwest Fire Department all respond with ambulances to treat the injured and remove the dead.

The Pima County and State of Arizona Emergency Operations Centers would be activated to support the event. This would cause the Pima County Emergency Management Agency to activate. The derailment of the train would cause the National Transportation Safety Board to be directly involved in the response due to their desire to keep all evidence in tact until an investigation could be conducted. The following is a list of the agencies that would be involved, the networks they would be grouped in and the frequencies used to communicate:

| | Primary | Alternate |
|---|---|---|
| Command Network #1 | | |
| Union Pacific Railroad | 160.4850 | |
| Tucson Police Department | 154.7250/158.8000 | |
| Tucson Fire Department (Fire/EMS) | 453.2500 Simplex | |
| FBI | 167.7500 | |
| Pima County Emergency Management | 868.0125/823.0125 | |
| 5 Radios Used | | |
| Fire Network #2 | | |
| Northwest Fire | 154.2800* | 153.9500 Simplex |
| Rural/Metro (Fire) | 154.2800* | 154.4000 Simplex |
| Tucson Fire Department | 453.2500 | 453.3250 Simplex |
| *State Fire Mutual Aid Channel | | |
| 2 Radios used in Primary | | |
| 3 Radios used in Alternate | | |
| Law Enforcement Network #3 | | |
| AZ DPS | 460.3750/465.3750 @ | 460.4250/465.4250 |
| AZ Dept of Transportation | 460.3750/465.3750 @ | 453.0250/458.0250 |
| Pima Co. Sheriff | 866.5125/ @ | 867.0125/822.0125 |
| National Transportation Safety Board | 167.2500$ | 162.2625/167.2500 |
| FBI | 167.2500$ | 163.9375/167.4875 |
| @ Tri-Band Radio System | | |
| $Federal Interoperability Channel | | |
| 2 Radios used in Primary | | |
| 5 Radios used in Secondary | | |
| EMS Network #4 | | |
| Rural/Metro (Ambulance) | 463.0000/468.0000% | 154.3250/153.9050 |
| Northwest Fire (Ambulance) | 463.0000/468.0000% | 153.9500 Simplex |
| Tucson Fire Department (EMS) | 463.0000/468.0000% | 453.2500 Simplex |
| %EMSCOM Channel | | |
| 3 Radios used in Primary and Alternate | | |

This scenario requires at least 12 modules from the ACU1000 to support all the agencies involved. The ACU1000 to be used in this scenario is located at the Pima County Sheriff's Dispatch Center. Presently that unit is configured with 10 radio and 2 telephone modules. That unit can be reconfigured to accommodate 12 radio modules.

In the event that multiple ACU1000s are used, it becomes necessary to tie the switches together physically to support controlling the devices. This physical connection can be achieved through Wide Area Networks or the use of wireless means like a 80211.g “Hot Spot. The 2 devices must also share RF connection by means of matching frequencies within the Networks. An example of this can be accomplished by using the same radio frequency in each network on the “Pima County” Switch as is used for the “Tucson” Switch (i.e. the 2 Fire Networks would both have a radio tuned to 154.2800 State Fire Mutual Aid).

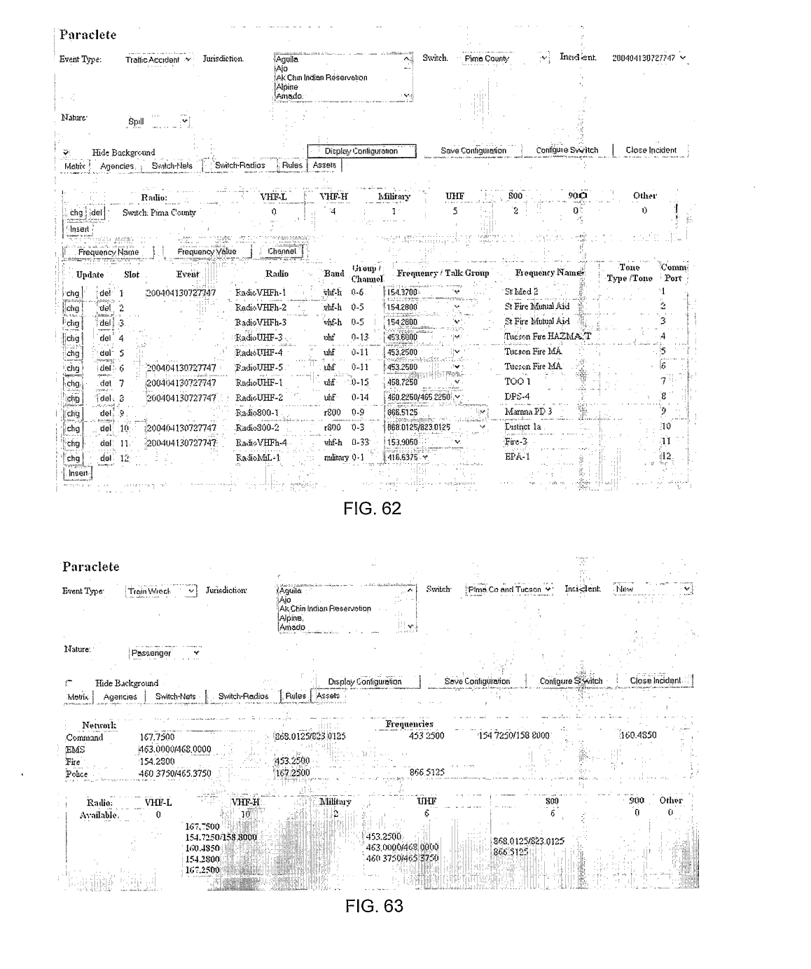

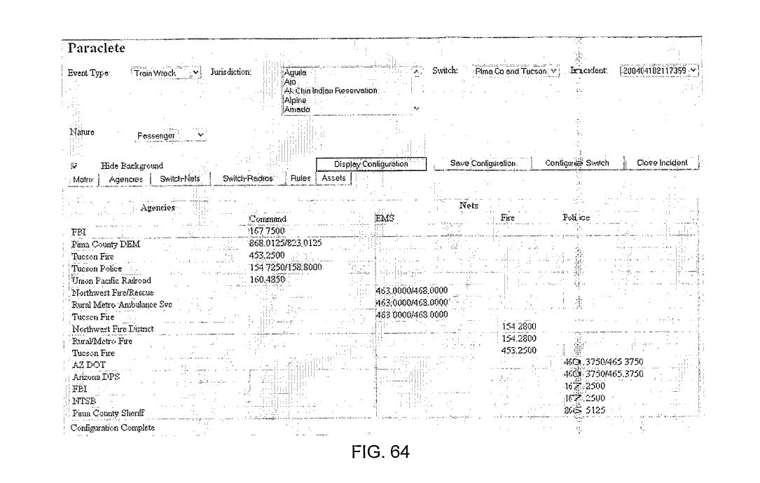

FIGS. 63-65 show screen displays for Example Scenario #5. In this case, the county's “Tri-Band” Repeater System was used to support the Law Enforcement Network. Tucson/Pima County uses this system on a regular basis. This situation shows the versatility the system can provide with its ability to utilize any existing cross-communication solutions.

As can be seen in the scenarios communication plan, there are alternate frequencies established so that if another event were to take place within radio range of this event, the system would have alternate frequencies to use to support the other event. The alternate frequencies can also be used if this event was established after another event that was already using the primary frequencies. The Command Network frequencies do not need alternates because the system sees these frequencies as “Command” assets as opposed to “Operations” assets and does not require a secondary frequency to go to.

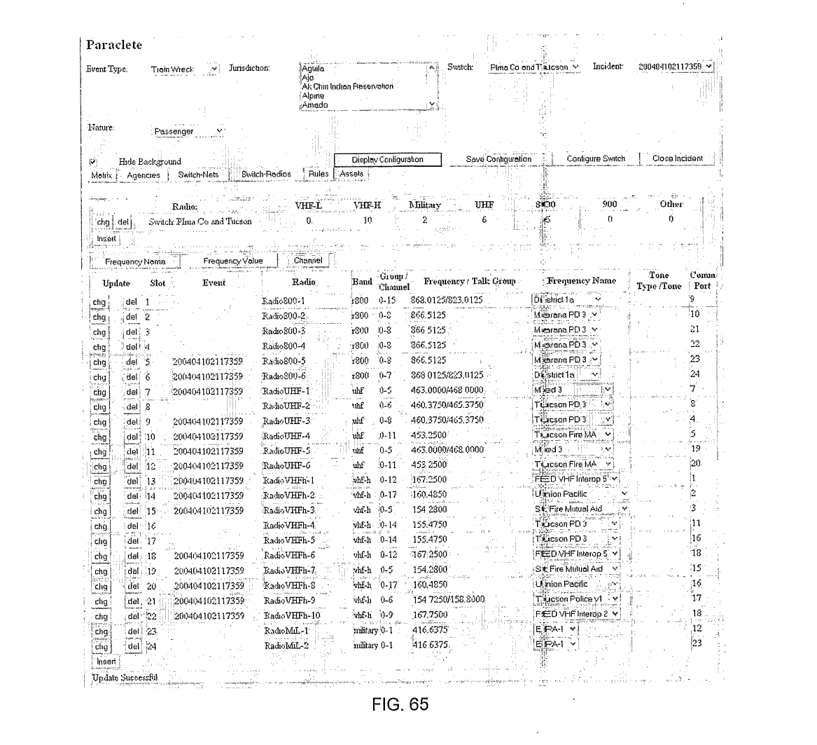

Note that when combining switches that are not physically connected together it is necessary to insure that there is at least one radio on both switches tuned to the same channel for each net (see FIG. 65). Thus the number of available channels when combining switches is the sum of the radios minus the number of nets.

### Example Scenario #6

### Freight Train Collision with Vehicle Near Red Rock, Ariz.

This scenario is an example of a real life situation in that it illustrates a requirement for more communications than can be supported by the mobile switch. The incident can still be handled effectively by handing a member of the command staff a different radio that shares a frequency that is supported on the command net.

In this scenario, a freight train collides with an Arizona Public Service (APS) vehicle at the crossing at Sasco Rd. This crossing is approximately 1 mile Northwest of the APS Power Plant. The train de-rails, causing 4 cars to rollover. These cars are carrying contaminated acid on their way to Nogales, Sonora to be filtered. The resulting cloud of acid vapor is blown Southeast toward the APS plant. This particular location is on the Maricopa/Pinal County border. This situation would cause several agencies to respond. Among those responding would be the Maricopa and Pinal County Sheriff, Arizona Public Service, Eloy Fire District, Eloy Police Department, Arizona Department of Public Safety (DPS), Rural/Metro Fire, Southwest Ambulance, Tucson Fire Department HAZMAT Team, Marana Police Department, Arizona State Department of Emergency Management, the Federal Emergency Management Agency and the National Transportation Safety Board.

Pinal County Sheriff's Department, Eloy Police and Fire Departments, Rural/Metro Fire, APS, FEMA and NTSB all have VHF Band radio systems. Maricopa County Sheriff, Marana Police Department use 800 MHz band radio system. DPS, Southwest Ambulance and Tucson Fire use the UHF band and Arizona Department of Emergency Management uses the RACES/HAM band within the VHF band. The following is a list of the agencies that would be involved, the networks they would be grouped in and the frequencies used to communicate:

| | Primary | Alternate |
|---|---|---|
| Command Network #1 | | |
| Pinal County Sheriff | 159.0600/151.0850 | |
| Rural/Metro Fire | 154.3700 | |
| Southwest Ambulance | 460.9500/465.9500 | |
| 4 Radios used | | |
| Fire Network #2 | | |
| Eloy Fire District | 154.2800* | 154.1600/151.0250 |
| Rural/Metro Fire | 154.2800* | 154.4000 Simplex |
| Tucson Fire Department | 453.6000/458.6000 | 453.3000 Simplex |
| *State Fire Mutual Aid | | |
| 2 Radios used in Primary | | |
| 3 Radios used in Alternate | | |
| Law Enforcement | | |
| Network #3 | | |
| Pinal County Sheriff | 158.8950/155.7450 | 155.4600 Simplex |
| Pima County Sheriff | 866.0125/821.0125 # | 867.0125/822.0125 |
| Marana Police Department | 866.0125/821.0125 # | 855.9625 Trunked |
| AZ DPS | 460.2250/465.2250 | 460.4250/465.4250 |
| APS | 153.4850 Simplex | 153.5900 |
| # 800 MHz Inter-Agency | | |
| 4 Radios used in Primary | | |
| 5 Radios used in Alternate | | |
| EMS Network #4 | | |
| Southwest Ambulance | 462.1000/467.1000 | 460.9500/465.9500 |
| Rural/Metro (Ambulance) | 155.8650/154.8900 | 154.3250/153.9050 |

2 Radios used in Primary and Alternate

| | | |
|---|---|---|
| HAZMAT Network #5 | | |
| Tucson Fire HAZMAT | 453.2500 Simplex | 453.3250 Simplex |
| Team | | |
| Rural/Metro HAZMAT | 154.2500 | 154.1750/150.7750 |

2 Radios used in Primary and Alternate

The Law Enforcement Network will be mostly involved in evacuation and securing the perimeter of the event. This effort will be communications intensive. The nature of the HAZMAT component of this event will probably cause several more agencies to respond to the event. If this is the case, MMRS would be notified and Fire/HAZMAT/EMS units from Maricopa County would be called in to support the units from Pinal and Pima Counties.

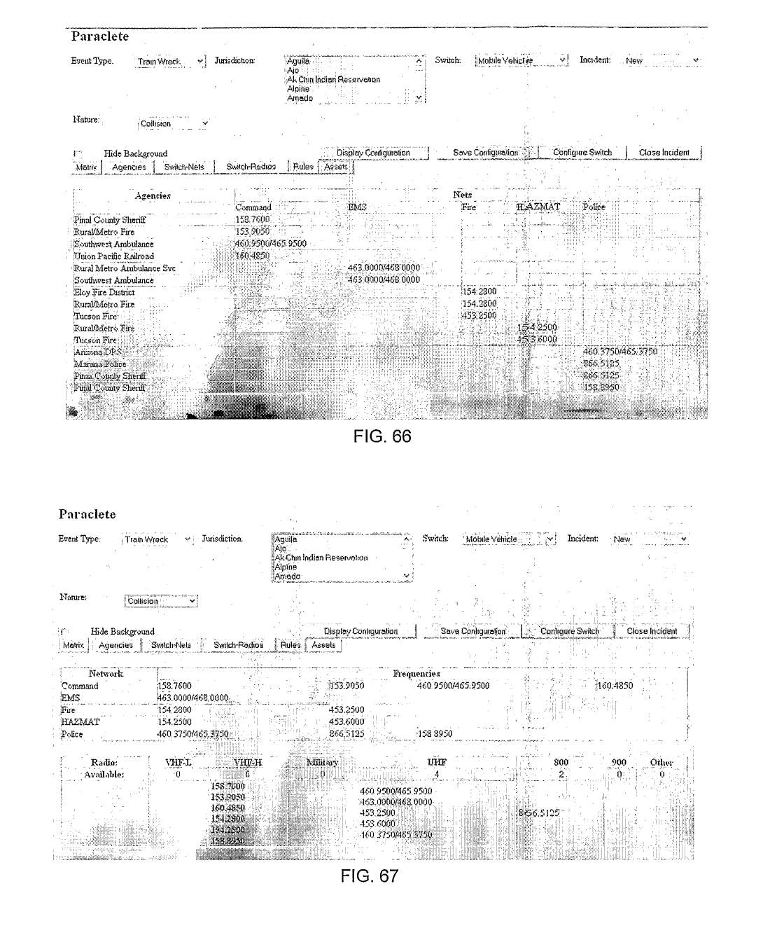

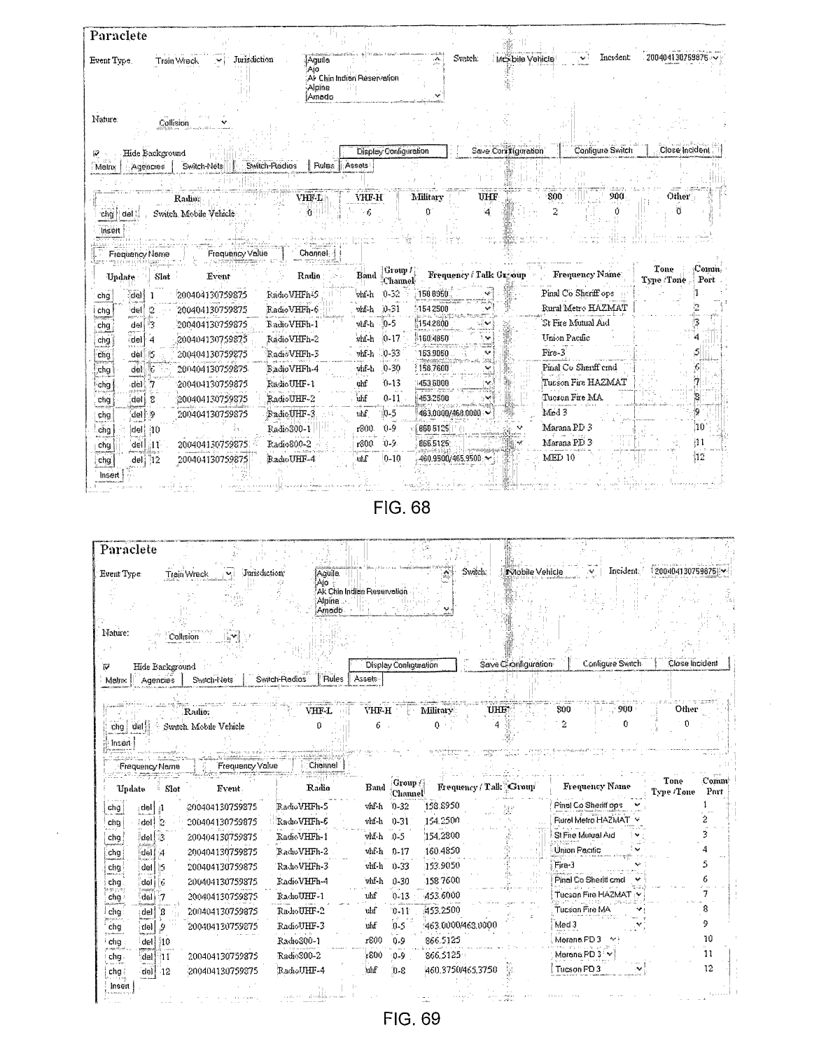

FIGS. 66-69 show screen displays for Example Scenario #6. As can be seen in the scenario's communication plan, there are alternate frequencies established so that if another event were to take place within radio range of this event, the system would have alternate frequencies to use to support the other event. The alternate frequencies can also be used if this event was established after another event that was already using the primary frequencies. The Command Network frequencies do not need alternates because system sees these frequencies as “Command” assets as opposed to “Operations” assets and does not require a secondary frequency to go to (see FIG. 66).

In the event that multiple ACU1000s are used, it becomes necessary to tie the switches together physically to support controlling the devices. This physical connection can be achieved through Wide Area Networks or the use of wireless means like a 80211.g “Hot Spot. The 2 devices must also share RF connection by means of matching frequencies within the Networks. An example of this can be accomplished by using the same radio frequency in each network on the “Pima County” Switch as is used for the “Tucson” Switch (i.e. the 2 Fire Networks would both have a radio tuned to 154.2800 State Fire Mutual Aid).

Note that the frequency 460.3750/465.3750 is depicted in red since there is no radio on the switch to support it. We will go ahead and configure the switch as shown above and then modify the channel setting on one of the radios to cover the police frequency that needs to be supported. (See FIG. 68)

As shown in FIG. 69, we have changed the radio supporting the Med-10 channel to Tucson PD-3. Med-10 was being used by a single individual in the command net. That individual will be given a radio with one of the other command net channels this frees up the needed UHF radio for operational use.

### Example Scenario #7

### Explosion at Remote Border Crossing

The border crossing at Lukeville, Ariz. is a remote crossing. It serves the popular tourist attraction of Rocky Point on the Sea of Cortez which is approximately 50 miles south of the border. At the Lukeville Border Crossing, a freight truck filled with fertilizer and fuel is exploded by a terrorist organization. The terrorist was hoping to slip the truck through the border at the remote crossing. When the customs agent began to search the truck the terrorist killed himself setting off the explosives. The damage from the explosion is extremely extensive. The number of dead would be in excess of one hundred people, with injuries reaching one hundred to one-hundred-fifty people traveling to or from the Rocky Point. The associated fire would require all of the local Fire Departments' resources. The large amount of dead and injured, coupled with the rural nature of the location, will quickly overwhelm local resources. A disaster of this magnitude would require many outside resources from state and county agencies.

The Lukeville Border Crossing is extremely remote in relation to the populace areas of Southern Arizona. Response times for this scenario would be extremely long in comparison to the Border Crossings at San Luis, Nogales or Douglas. It would be necessary for the initial responders to utilize the State Fire Mutual Aid Channel and perhaps the Law Enforcement Interagency Channels until the State's Mobile Command Vehicle could be deployed. The arrival of this vehicle could take at least one hour. The needed support from the rest of Pima County and the neighboring counties would take at least that long to arrive. The American First Responders would probably need to use the services of the Fire Department in Sonoyta, Mexico in the interim. Agreements are in place for mutual aid between Lukeville and Sonoyta.

In this scenario, the Incident Commander, from the Why Fire District, would arrive on scene within 30 minutes of the explosion. His first communications would be to the Organ Pipe Cactus National Monument Park Rangers, as well as Ajo and the Tohono O Odham Fire Departments. This would be accomplished using the “Fire Mutual Aid” Channel. The Ajo-Gibson Volunteer Fire Department and the Why Fire District units would have to make initial entry to the damaged area as OPCNM Rangers establish road blocks and re-routes traffic. During this initial action the fire units and OPCNM Rangers could communicate via the State Fire Mutual Aid Channel. All available units would be used to put out the fire. This would mean that outside resources would be needed to treat victims after their removal from the hot zone, as well as removal of the dead to the county's morgue facilities. Due to the remote nature of the Lukeville area, it may become necessary to establish a Military Mobile Field Hospital. In order to support communications with the outside agencies the incident commander would use “State Fire Mutual Aid”.

As units arrive from Tucson, Maricopa County and the State and Federal Agencies, it will now become necessary to interconnect these agency's communications. Each of these groups would communicate within their group on “Car-to-Car” or “Simplex” channels, while their command staffs would communicate between the groups through the interoperability system on Inter-Agency channels. This is done to keep the amount of voice traffic on the system to a manageable level. If fifty entities tried to all use the same network at the same time, nobody would be understood, and nothing would get accomplished.

Once the State Mobile Command Vehicle arrives, multi-jurisdictional communications would be established via the vehicles Interoperability device equipped with the system. The following is a list of the agencies that would be involved, the networks they would be grouped in and the frequencies used to communicate:

| | Primary | Alternate |
|---|---|---|
| Command Network #1 | | |
| Why Fire District | 150.8050 | |
| Pima County Sheriff | 868.0125/823.0125 # | |
| Pima County Emergency Management | 868.0125/823.0125 # | |
| Southwest Ambulance | 460.9500/465.9500 | |
| FBI | 167.7500 \hat{ } | |
| ATF | 167.7500 \hat{ } | |
| # 800 MHZ Interagency Channel | | |
| \hat{ } Federal Interoperability Channel | | |
| 4 Radios used | | |
| Fire Network #2 | | |
| Why Fire District | 154.2800* | No Alternate |
| Ajo-Gibson Fire Department | 154.2800* | 154.1600/156.0150 |
| Sonoyta, Mexico Fire Department | 163.8650/168.8650 | No Alternate |
| Tucson Fire Department | 453.2500 | 453.3000 Simplex |
| Rural/Metro (Yuma) | 154.2800* | 154.3700 Simplex |
| Tohono O Odham Fire Department | 154.2800* | |
| *State Fire Mutual Aid | | |
| 3 Radios used in Primary | | |
| 5 Radios used in Alternate | | |
| Law Enforcement Network #3 | | |
| Pima County Sheriff | 866.5125 Simplex | 867.0125/822.0125 |
| AZ DPS | 460.3750/465.3750 # | 460.4250/465.4250 |
| AZ Dept of Transportation | 460.3750/465.3750 # | 453.0250/458.0250 |
| National Transportation Safety Board | 167.2500 Simplex \hat{ } | 162.2625/167.2500 |
| FBI | 167.2500 Simplex \hat{ } | 163.9375/167.4875 |
| U.S. Border Patrol | 167.2500 Simplex \hat{ } | 164.0500/162.9500 |
| OPCNM Rangers | 167.2500 Simplex \hat{ } | 164.4250/163.1250 |
| \hat{ } Federal Interoperability Channel | | |
| # Law Enforcement Interagency | | |
| 3 Radios used in Primary | | |
| 6 Radios used in Alternate | | |
| EMS Network #4 | | |
| Rural/Metro (Ambulance) | 463.000/468.000 | |
| LifeNet Med. Helicopter | 463.000/468.000 | |
| Southwest Ambulance | 463.000/468.000 | |
| Davis-Monthon Medical | 173.4875 Simplex | 148.1850 Simplex |
| 2 Radios used in Primary and Alternate | | |

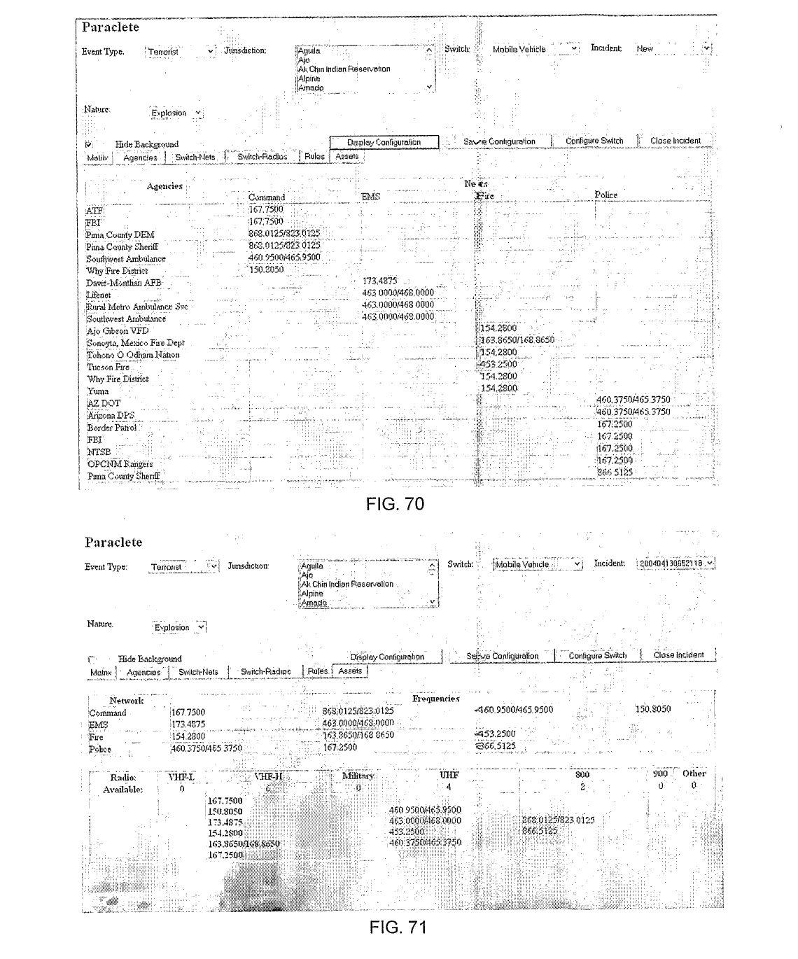

FIGS. 70-72 show screen displays for Example Scenario #7. Using the scenario above, the operator would select the effected location on the map. The system would change to the system interface page with the jurisdiction already selected in the “Jurisdiction” window. The operator would then pull-down the “Event” window and select “Terrorist”. The operator would then pull down the “Nature” window and select “Explosion”. Since Sells, Ariz. is not covered by any fixed switch the default switch is “Mobile.” Pima County would need to dispatch the switch from Tucson. The operator would then select “Display Configuration.” The system will go to its database and find the prescribed agencies and display the Network configurations, agencies involved and the frequencies to be used. (See FIG. 70) The operator would select “Configure Switch.” The system will make the correct channel selections on the associated radios and make the patches necessary to support the intended networks. Twelve radios would be necessary to support this scenario (see FIG. 71).

If there are not enough radios of a particular band available to support the event, the system will show the frequencies/channels that cannot be supported/connected in red on the “Configuration Page.” The system allows the operator to decide which agencies will be deleted to support the new event, or which agencies in the new event that will not be supported. If another Interoperability device is available, the system allows the operator to take control of that device and complete the required connections/selections to support the event.

As shown in FIG. 72, at this point all prescribed communications for this event have been connected. Selecting the “add” button and selecting the agency/channel from the pull-down list can add any additional communications needs that may be required during the event.

In the event that multiple ACU1000s are used, it becomes necessary to tie the switches together physically to support controlling the devices. This physical connection can be achieved through Wide Area Networks or the use of wireless means like a 80211.g “Hot Spot. The 2 devices must also share RF connection by means of matching frequencies within the Networks. An example of this can be accomplished by using the same radio frequency in each network on the “Pima County” Switch as is used for the “Tucson” Switch (i.e. the 2 Fire Networks would both have a radio tuned to 154.2800 State Fire Mutual Aid).

### Example Scenario #8

### Search and Rescue Operations

Pima County has several remote areas. If a hiker were to fall down a ravine or become lost in the remote areas of the county, it would become necessary to utilize resources from several agencies. This would include DPS, State Land Management, State Game and Fish and Pima County Sheriff's resources.

In this scenario connecting DPS, State Game and Fish and State Land Management together on the “State Land Inter-Agency” channel and patching that group to one of the Pima County Sheriff's conventional 800 MHz channels would make the communications necessary to support this event. The State Land Inter-agency channel should be programmed into the radios of the agencies listed above. The following is a list of the agencies that would be involved, the networks they would be grouped in and the frequencies used to communicate:

| Event Network #1 | Primary | Alternate |
|---|---|---|
| Pima County Sheriff | 864.1000/819.1000 | |
| AZ DPS | 460.3750/465.3750 | |
| AZ Game and Fish | 151.4150/159.4350 | |
| AZ Land Management | 151.4150/159.4350 | |

This configuration only uses one Network with no alternate frequencies. This would be sufficient due to the limited time frame needed to support this event and the fact that all the frequencies used are considered either mutual aid channels or the agencies have multiple channels and normal traffic could be cleared to those other channels.

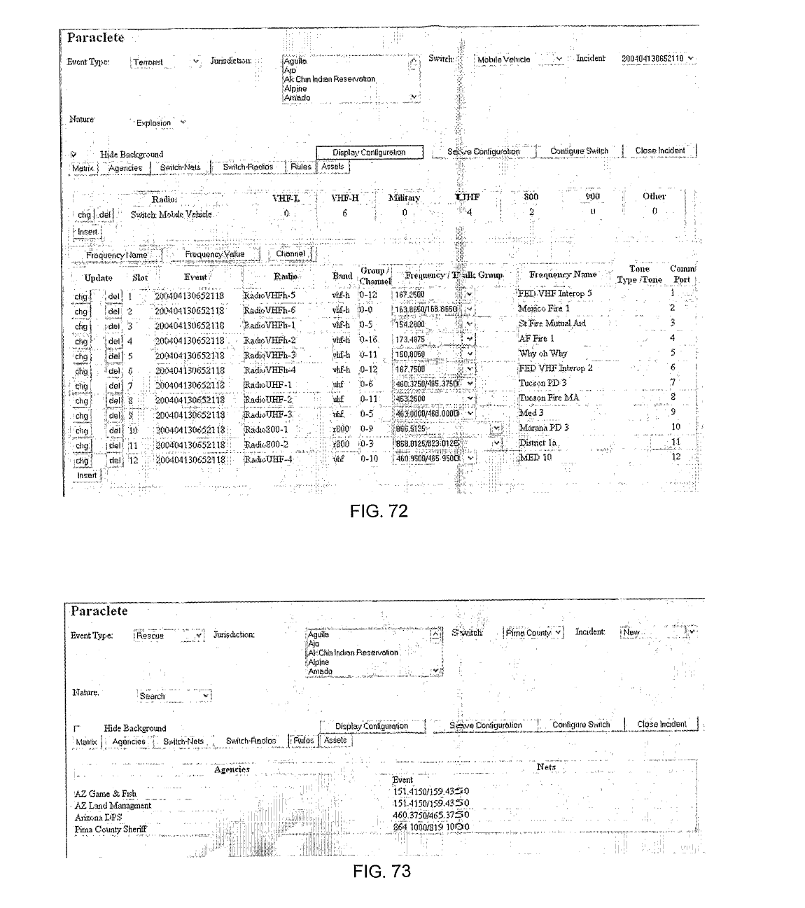

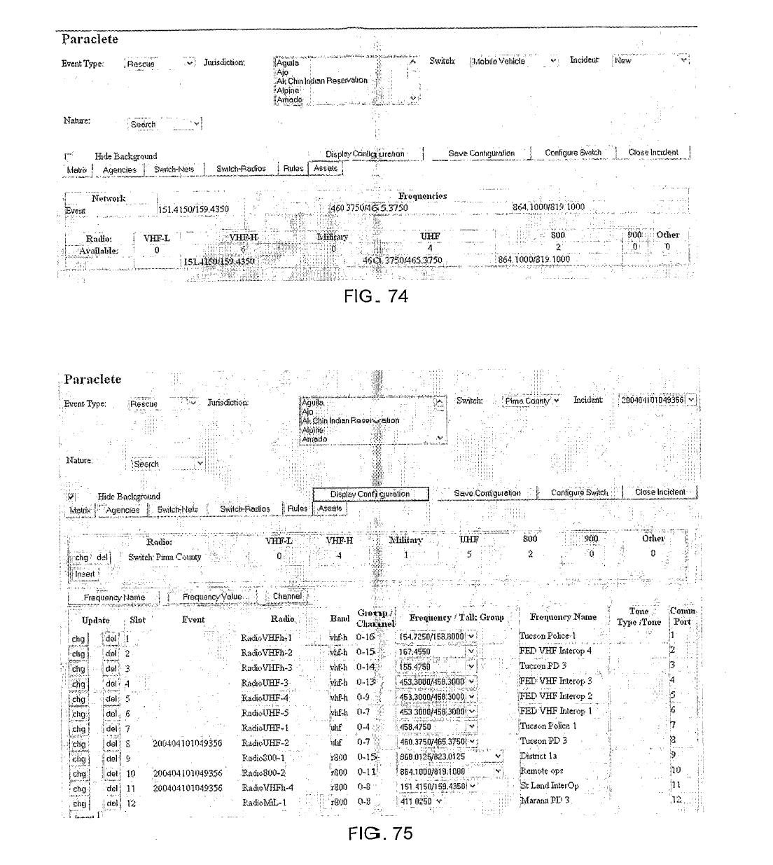

FIGS. 73-75 show screen displays for Example Scenario #8. Using the scenario above, the operator would select the effected location on their map. The system would change to the system interface page with the jurisdiction/jurisdictions already selected in the “Jurisdiction” window. Since multiple jurisdictions would be involved, the operator could pull-down the “Jurisdiction” window and select the other possible jurisdictions. The operator would then pull-down the “Event” window and select “Rescue”. The operator would then pull down the “Nature” window and select “Search”. The operator would then select “Configure Switch”. The system will go to its database and find the prescribed agencies and display the Network configurations, agencies involved and the frequencies to be used. The operator would select “Apply”. The system will make the correct channel selections on the associated radios and make the patches necessary to support the intended networks.

If other events are already being supported and there are not enough radios of a particular band available to support the event, the system will show the frequencies/channels that cannot be supported/connected in red on the “Configuration Page”.

The system allows the operator to decide which agencies will be deleted to support the new event, or which agencies in the new event that will not be supported. If another Interoperability device is available, the system allows the operator to take control of that device and complete the required connections/selections to support the event.

As shown in FIG. 75, at this point all prescribed communications for this event have been connected. Selecting the “add” button and selecting the agency/channel from the pull-down list can add any additional communications needs that may be required during the event.

As can be seen in the scenario's communication plan, there are alternate frequencies established so that if another event were to take place within radio range of this event, Paraclete would have alternate frequencies to use to support the other event. The alternate frequencies can also be used if this event was established after another event that was already using the primary frequencies.

### CONCLUSION

From the foregoing, it can be seen that the method and system of the present invention possess numerous advantages. Additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept.

What is claimed is:

1. A method for managing a communication interoperability switch and communication devices associated with the switch, the method comprising:
storing data in a computer database, the data including:
jurisdiction data representing one or more jurisdictions, wherein each jurisdiction defines operational boundaries of one or more agencies;
agency data including one or more communication device frequencies associated with the one or more agencies;
rules for selecting one or more communication device frequencies and one or more networks of the selected communication device frequencies; and
using the stored rules to automatically determine configuration information for configuring the switch to interconnect a communication device to be operated by an agency selected from the one or more agencies;
whereby the switch can be configured to interconnect the communication devices operated by the selected agencies.

2. The method of claim 1 wherein the configuration information includes a plurality of communication devices and one or more nets of the selected communication device frequencies

3. The method of claim 1 further comprising transmitting the switch configuration to the communications switch.

4. The method of claim 1 wherein the rules for selecting communication device frequencies and nets are based on one or more selected event jurisdictions, a selected event type and a selected event nature

5. The method of claim 1 wherein the data stored in the computer database includes incident data including one or more event types and one or more event natures.

6. The method of claim 4 wherein the rules for selecting communication device frequencies and nets are based on a selected incident including a selected event type, a selected event nature and one or more selected event jurisdictions.

7. A system for automatically configuring a communication interoperability switch and communication devices associated with the switch, the system comprising:
a database for storing data including:
jurisdiction data representing one or more jurisdictions, wherein each jurisdiction defines operational boundaries of one or more agencies;
agency data including one or more communication device frequencies associated with the one or more agencies;
rules for selecting one or more communication device frequencies and one or more networks of the selected communication device frequencies;
an application program operable with the database to:
use the stored rules to automatically determine configuration information for configuring the switch to interconnect a communication device to be operated by an agency selected from the one or more agencies;
whereby the switch can be configured to interconnect the communication device operated by the selected agency with other communication devices.

8. The system of claim 7 further comprising a transmitter operable with the application program to transmit the switch configuration to the communication interoperability switch.

9. The system of claim 7 further comprising a mapping program operable with the database to pass the one or more selected event jurisdictions to the application program in response to an input representing an event location.

10. The system of claim 7 wherein the configuration information includes a plurality of communication devices and one or more networks of the selected communication device frequencies

11. The system of claim 7 wherein the rules for selecting communication device frequencies and nets are based on one or more selected event jurisdictions, a selected event type and a selected event nature

12. The system of claim 7 wherein the data stored in the computer database includes incident data including one or more event types and one or more event natures.

13. The system of claim 12 wherein the rules for selecting communication device frequencies and nets are based on a selected incident including a selected event type, a selected event nature and one or more selected event jurisdictions.
